(19) United States
(12) Patent Application Publication
(10) Pub. No.: US 2026/0300292 A1
(43) Pub. Date: Oct. 1, 2026

(54) COMPLETENESS-AWARE DISTRIBUTED GRAPH QUERY PLANNING

(71) Applicant: Microsoft Technology Licensing, LLC, Redmond, WA (US)

(72) Inventors: Lisa Viola Viktoria JONSSON, Tromso (NO); Jan-Ove Almli KARLBERG, Tromso (NO); Anders Tungeland GJERDRUM, Tromso (NO); Theodoros GKOUNTOUVAS, Tromso (NO)

(21) Appl. No.: 19/096,562

(22) Filed: Mar. 31, 2025

(51) Int. Cl. G06F 16/2453

(52) U.S. Cl. CPC G06F 16/24542

(57) ABSTRACT

Methods, systems, and computer storage media for programmatically retrieving data from a distributed data source by receiving a query to obtain data from the distributed data source that comprises one or more data sources and determining a completeness criteria corresponding to each data source of the distributed data source based on the query. The data is retrieved by generating a query plan comprising a plurality of sub-plans to satisfy the query based on the completeness criteria, generating a plurality of sub-queries corresponding to the sub-plans, submitting the plurality of sub-queries to the distributed data source, and providing a response to the query based on responses to the plurality of sub-queries.

### BACKGROUND

Typically, a knowledge graph stores data in a graph database. The data is structured in a graph format, with storage locations represented as nodes and relationships between those locations as edges, in the graph database. Thus, when a graph-based operation, such as a graph query, is performed on the knowledge graph that requires data to be accessed, the data is accessed through the graph database. A graph metaphor models data stored in databases in various formats to resemble a knowledge graph, with entities determined from the databases represented as nodes and relationships as edges. The graph metaphor can be applied to data stored in a multitude of database in various formats. In this regard, when a graph-based operation, such as a graph query, is performed on the graph metaphor that requires the data to be accessed, the data is accessed through the database in the corresponding format of the database.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Implementations of the technology provided in the present disclosure are directed towards technologies for improving searching computing applications and user computing experiences on user computing devices (sometimes referred to herein as user devices). In particular, this disclosure provides technologies to programmatically collecting disconnected, partially overlapping, or overlapping semantically linked data into a single coherent graph abstraction using completeness criteria. The completeness criteria provide the ability to determine where any overlap of the data exists and which data source contains the richest, or most complete, set of data. The technologies described herein use a graph metaphor representing a plurality of data sources, such as different regions of a federated database system, including nodes representing entities of the plurality of data sources, such as files stored in the data sources, and edges representing relationships between the nodes. The node properties stored in the nodes of the graph metaphor include metadata describing the entity, such as the name and data source location of the entity, and/or query properties indicating constraints when querying the entity. One such constraint is completeness of the data at each node, which is a measure of how complete the set of data is. In this regard, for a node representing data of a data source, the node properties, such as completeness, are stored in the graph metaphor while the data itself is stored in the data source. The edge properties include metadata describing the relationship and/or query properties indicating constraints when querying the edge. A graph query is received and parsed to determine a representation of query candidates from the graph metaphor, such as data sources and/or regions of the federated database system that are queried in order to determine a response to the graph query. A query plan is determined based on the set of query steps in order to query each of the query candidates and optimize the execution of the query. This query plan can balance the completeness of various nodes with speed of access of those nodes to perform the most efficient execution of the query. The query plan, also referred to herein as a query execution plan, is executed by distributing queries of the candidate data sources through adapters, interfaces, and plug-ins for each of the data sources. The distributed queries can be executed in sequence, in parallel, or using a combination of these execution methods. The results of the query plan are combined into a query result and presented to the user in response to the query.

### BRIEF DESCRIPTION OF THE DRAWINGS

The technology described herein is described in detail below with reference to the attached drawing figures, wherein:

FIG. 1 is a block diagram illustrating an example operating environment suitable for implementations of the present disclosure;

FIG. 2 is a block diagram illustrating an example computing architecture suitable for implementing aspects of the present disclosure;

FIG. 3 is a block diagram illustrating an example distributed graph query engine capable of collecting disconnected semantically linked data into a single coherent graph abstraction through a schema, using completeness criteria, in accordance with an implementation of the present disclosure;

FIG. 4 is a block diagram illustrating an example federated graph query system capable of collecting disconnected semantically linked data into a single coherent graph abstraction, using completeness criteria, in accordance with an implementation of the present disclosure;

FIGS. 5-8 are block diagrams illustrating example query plans that are determined by programmatically determining and optimizing distributed graph queries of a graph metaphor of distributed data sources, in accordance with an implementation of the present disclosure;

FIG. 9 is a block diagram illustrating example calculations of completeness of nodes in an example federated graph query system, in accordance with an implementation of the present disclosure;

FIG. 10 is a block diagram illustrating an example execution plan for programmatically distributing graph queries of a graph metaphor of distributed data sources using completeness criteria, in accordance with an implementation of the present disclosure;

FIG. 11 is a block diagram illustrating an example schema for programmatically distributing graph queries of a graph metaphor of distributed data sources using completeness criteria, in accordance with an implementation of the present disclosure;

FIG. 12 is a block diagram illustrating completeness in overlapping datasets, in accordance with an implementation of the present disclosure;

FIG. 13 is a block diagram illustrating completeness in non-overlapping datasets, in accordance with an implementation of the present disclosure;

FIG. 14 is a flow diagram of a method for obtaining disconnected semantically linked data using completeness criteria, in accordance with an implementation of the present disclosure;

FIG. 15 is a flow diagram of a method for obtaining disconnected semantically linked data using completeness criteria, in accordance with an implementation of the present disclosure;

FIG. 16 is a block diagram of an example computing environment suitable for use in implementing an implementation of the present disclosure; and

FIG. 17 is a block diagram of an example computing environment suitable for use in implementing an implementation of the present disclosure.

### DETAILED DESCRIPTION

The subject matter of aspects of the present disclosure is described with specificity herein to meet statutory requirements. However, the description itself is not intended to limit the scope of this patent. Rather, it has been contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone application, a service or hosted service (stand-alone or in combination with another hosted service), or a plug-in to another product, to name a few.

Aspects of the present disclosure relate to technology for improving electronic communication technology and enhanced computing services for a user, based on determining and optimizing distributed graph queries. In particular, the solutions provided herein include technologies for programmatically optimizing distributed graph queries by using completeness criteria to ensure data completeness and improve query performance. The technologies described herein use a graph metaphor representing a plurality of data sources, such as different regions of a federated database system, including nodes representing entities of the plurality of data sources, such as files stored in the data sources, and edges representing relationships between the nodes. For example, a graph metaphor representing a plurality of data sources, such as distributed databases, datastores (also referred to herein as “data stores”), services, applications, and/or others, is stored. Each data source of the plurality of data sources can be optimized to store different types of data. The graph metaphor models entities of the plurality of data sources and relationships between the entities to provide semantic connections between the data of the plurality of data sources to abstract complex relationships into a more manageable form for graph-based operations without sacrificing the optimization of each of the plurality of data sources. For example, a data source is optimized for email storage to serve mail efficiently, such as by providing faster access to the most recent emails in response to queries and slower access to emails based on the age of the email. As another example, data sources can be optimized for quick access of small portions of data of a file, and the remaining portions of the file can be stored in different data sources.

In some implementations, the graph metaphor may correspond to a federated logical graph representing heterogeneous stores of a federated database system. A federated database system generally refers to a database architecture that integrates multiple autonomous and/or heterogeneous databases into a unified system, allowing the databases to function collectively while maintaining individual autonomy. Each region of the federated database system can refer to different databases or sets of databases of the federated database system. For example, each region of the federated database system may differ by geographical location, administrative control, data type, and database management and storage solutions. The federated database system enables efficient data operations across diverse data sources through a unified interface, while preserving data locality, integrity, and efficiencies of the type of database. In this regard, each region of the federated database system can be optimized to store different types of data as well as to store the same data (for example, overlapping or partially overlapping data) differently. One example of storing overlapping or partially overlapping data differently applies to documents with different access methods such as using an identifier, providing an inverted index, or other access methods.

The graph metaphor includes nodes representing entities of the plurality of data sources (for example, heterogeneous stores of a federated database system) and edges representing relationships between the nodes. Examples of entities represented by nodes of the graph metaphor include data sources, such as each of the data sources modeled by the graph metaphor; users, such as individual users within an organization; groups, such as distribution lists; messages, such as email messages in a user's mailbox; events, such as calendar events in a user's calendar; files and/or portions of files, such as files and/or portions of files stored in each corresponding data source; devices, such as devices registered in the organization; applications, such as various applications that utilize files or data sources; and/or any other type of data and/or service stored and/or utilized by a data source.

Examples of relationships between nodes represented as edges of the graph metaphor, such as an edge (for example, named memberOf) that connects a user node to groups or roles that the user is a member of; an edge (for example, named manager) that connects a user node to another user node who is their manager; an edge (for example, named attachments) that connects an email or event node to files or items attached to it; an edge (for example, named createdByUser) that connects files, tasks, or other items to the user node of the person who created them; an edge (for example, named events) that connects a user or group node to the calendar events they are associated with; an edge (for example, named messages) that connects a user node to their email messages; an edge (for example, named ownedDevices) that connects a user node to devices they own within an organization; an edge (for example, named subscriptions) that connects a user or application node to notifications for changes in user data, messages, or other monitored resources; and/or any other type of relationship between any type of data and/or service stored and/or utilized by a data source.

The graph metaphor stores properties of the nodes and edges based on a corresponding type of entity and type of relationship, respectively. The node properties include descriptive attributes describing the entity, such as metadata indicating the name of the entity, metadata indicating the data source location of the entity, metadata describing the identity or uniqueness of the entity, and/or metadata about query properties of the entity indicating constraints to be used when querying the entity. In this regard, for a node representing data of a data source, only the node properties are stored in the graph metaphor while the data itself (for example, the content) is stored in the data source. The edge properties include descriptive attributes describing the relationship, such as metadata indicating a time when the relationship was created, and/or query properties indicating constraints when querying the edge, such as through an edge traversal.

Examples of query properties include an indication of available identifiers that can be used to query an entity, such as the type of descriptive identifier supported by a data source; an indication of available query functions, such as whether the entity can support edge traversal, a lookup of node by an identifier (or ID), a search function, and/or any other query function; access requirements, such as requiring a call to a security service to confirm access to data for the user; and/or any other properties that indicate constraints when querying. In some instances, query properties and graph metaphor properties are the same (for example, the graph metaphor properties include the query properties). In some instances, the graph metaphor properties and, by extension, the graph metaphor itself, make the query properties opaque by design so that the caller does not need to be aware of the query properties to generate a query and, instead, uses the graph metaphor.

A graph query is received and parsed to determine a representation of query candidates from the graph metaphor. The query candidates correspond to entities, such as data sources and/or regions of the federated database system, and/or relationships that are queried in order to determine a response to the graph query. For example, a user inputs a query for data, and the query is received via an application programming interface (API) of the graph metaphor. A query is applied to the graph metaphor as a graph query utilizing any known graph querying technique. A representation of query candidates corresponding to each node and/or edge of the graph metaphor is determined, which can be queried in order to determine a response to the graph query.

The query properties of each of the query candidates are used to determine a query plan. The query plan includes a set of query steps to be performed in order to query each of the query candidates. For example, the query plan can include a first step to meet access control requirements of a first data source corresponding to a query candidate, a second step to query the first data source, a third step to meet access control requirements of a second data source corresponding to a query candidate, and a fourth step to query the second data source.

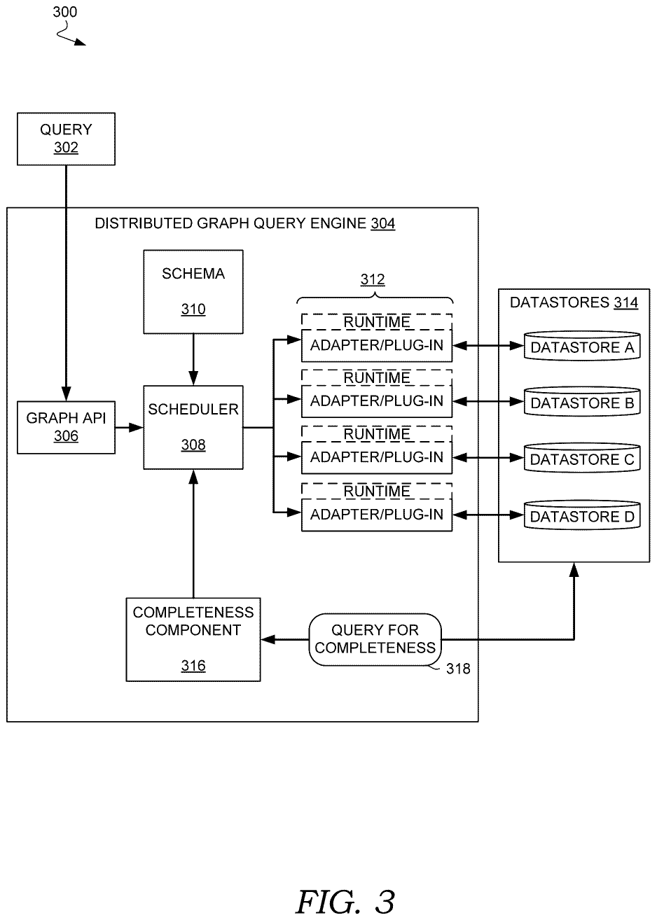

A query plan is programmatically determined based on the set of query operations or steps in order to optimize the execution of the query. The query plan is executed by executing distributed queries of the query candidates through plug-ins for each of the data sources, such as representational state transfer (REST) APIs, SQL database plug-ins, graph database plug-ins, search engine plug-ins, and/or any other plug-in for any type of data source. In some implementations, steps can be performed in parallel. For example, the first step to meet access control requirements of the first data source and the third step to meet access control requirements of the second data source can be performed in parallel, and the second step to query the first data source and the fourth step to query the second data source can be performed in parallel. Additional examples of programmatically distributing graph queries of a graph metaphor of distributed data sources are described in connection with FIGS. 3-13.

In some implementations, the query plan is determined based on completeness and/or cost, such as latency, reliability, usage of computational resources, and/or other similar factors, such as through statistics, rules, and/or heuristics. In some implementations, a machine learning model is used to determine the query plan based on available metrics, such as expected performance gain due to distribution of the queries to different data sources, the cost in terms of computational resources such as CPU utilization, memory consumption, latency, energy consumption, computational cost, statistics on how frequently the result of executing the access control logic is positive, and/or any other factors.

A query result is determined from the distributed queries of each of the data sources. For example, the results from execution of each of the distributed queries are combined, such as through a conflate operation and/or deduplicate operation to deduplicate redundant data. The query result is then presented to the user in response to the query.

### Overview of Technical Problems, Technical Solutions, and Technological Improvements

Conventional technology lacks computing functionality to automatically optimize distributed graph queries of a graph metaphor of distributed data sources based on completeness criteria to provide improved searching computing applications and an improved user computing experience. Consequently, because conventional technology lacks this functionality, in order to perform distributed graph queries of distributed data sources using completeness criteria, the data sources should be sequentially queried until the retrieved data is complete. Unfortunately, because the distributed graph queries of distributed data sources should be sequentially queried, the process increases latency and, is time-consuming and computationally expensive in order to sequentially query data sources and/or repeating access control determination steps. Similarly, because the obtained data is not guaranteed to be complete, the process can result in erroneous data and costly re-querying of the data sources. In this regard, additional computing and network resources are be utilized, such as increased processing requirements due to increased input/output operations, due to repeated queries, increased network bandwidth utilization when the data is transmitted over a network, or when data is accessed by the user, and in some instances, when there are longer and less efficient searching sessions between the user and the distributed data sources.

Accordingly, automated computing technology for programmatically determining and optimizing distributed graph queries of a graph metaphor of distributed data sources, based on completeness by determining a query plan from properties stored with respect to a graph metaphor and completeness criteria calculated at query time, as provided herein, can be beneficial for enabling improved computing applications and an improved user computing experience. For example, automated computing technology for programmatically distributing graph queries of a graph metaphor of distributed data sources using completeness speeds up the query execution and reduces the latency and/or computing and networking resources utilized during search query operations of a graph metaphor of distributed data sources by facilitating querying the distributed data sources and by eliminating costly re-querying operations on incomplete results. Querying the distributed data sources speeds up the query execution and reduces the latency and/or computing and networking resources utilized as the queries are executed across the distributed data sources (for example, as well as the corresponding database management system of each of the distributed data sources) allowing for rapid performance of data retrieval operations and/or access control operations. This reduces the total response time to the query. Additionally, basing a query execution plan on completeness can improve results and enable rapid culling of responses, eliminating unnecessary queries. In this regard, the speed of the query execution is increased, latency is decreased, data correctness is increased, and/or the computing and network resources are conserved.

Further, implementations provided in this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, implementations provided in this disclosure enable an improved user experience across a number of computer devices, applications, and platforms. Further still, implementations described herein enable the programmatic distribution of graph queries of a graph metaphor to distributed data sources based on completeness without requiring computer tools and resources for a user to manually perform operations to produce this outcome. In this way, some implementations, as described herein, reduce or eliminate a need for certain data sources, data storage, and computer controls for enabling manually performed steps by an administrator, or the user themselves, to search, identify, assess, and configure (for example, by hard-coding) specific, static data, thereby reducing the consumption of computing resources.

### Additional Description of the Implementations

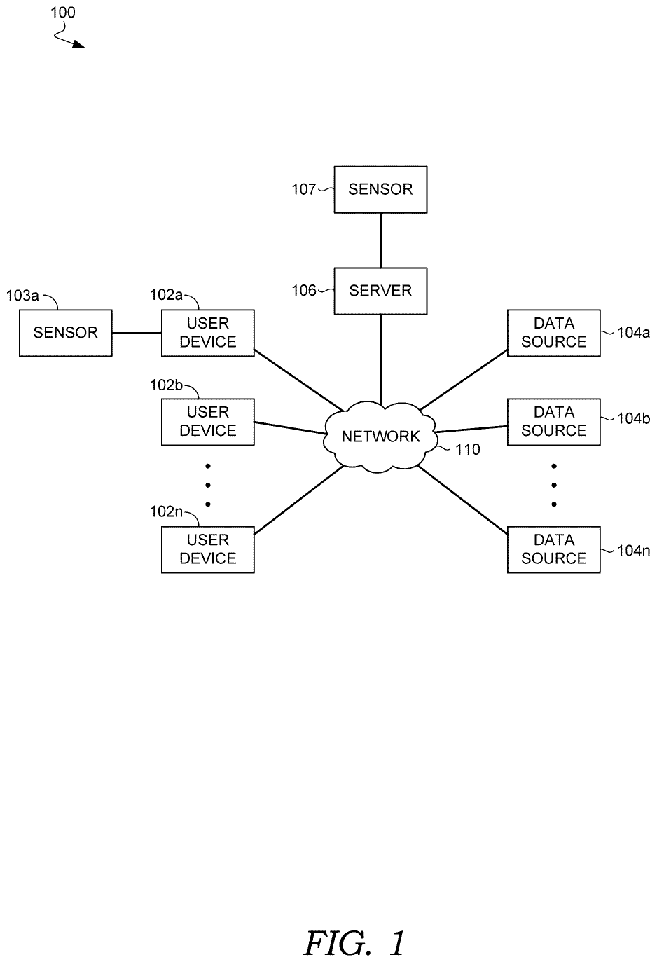

Turning now to FIG. 1, a block diagram is provided showing an example operating environment 100 in which some implementations of the present disclosure may be employed. It should be understood that this and other arrangements described herein are set forth only as examples. Other arrangements and elements (for example, machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

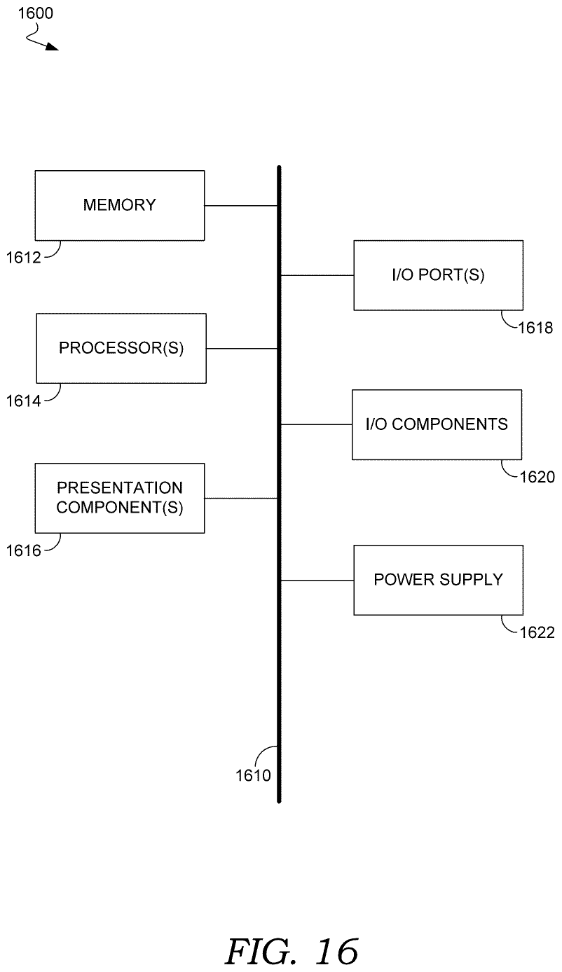

Among other components not shown, example operating environment 100 includes a number of user computing devices, such as: user devices 102a and 102b through 102n; a number of data sources, such as data sources 104a and 104b through 104n; server 106; sensors 103a and 107; and network 110. It should be understood that environment 100 shown in FIG. 1 is an example of one suitable operating environment. Each of the components shown in FIG. 1 may be implemented via any type of computing device, such as computing device 1600 described in connection to FIG. 16, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one implementation, user devices 102a through 102n may be the type of computing device described in relation to FIG. 16 herein. By way of example and not limitation, a user device may be embodied as a personal computer (PC), a laptop computer, a mobile or mobile device, a smartphone, a smart speaker, a tablet computer, a smart watch, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, any other suitable computer device, or any combination of these delineated devices.

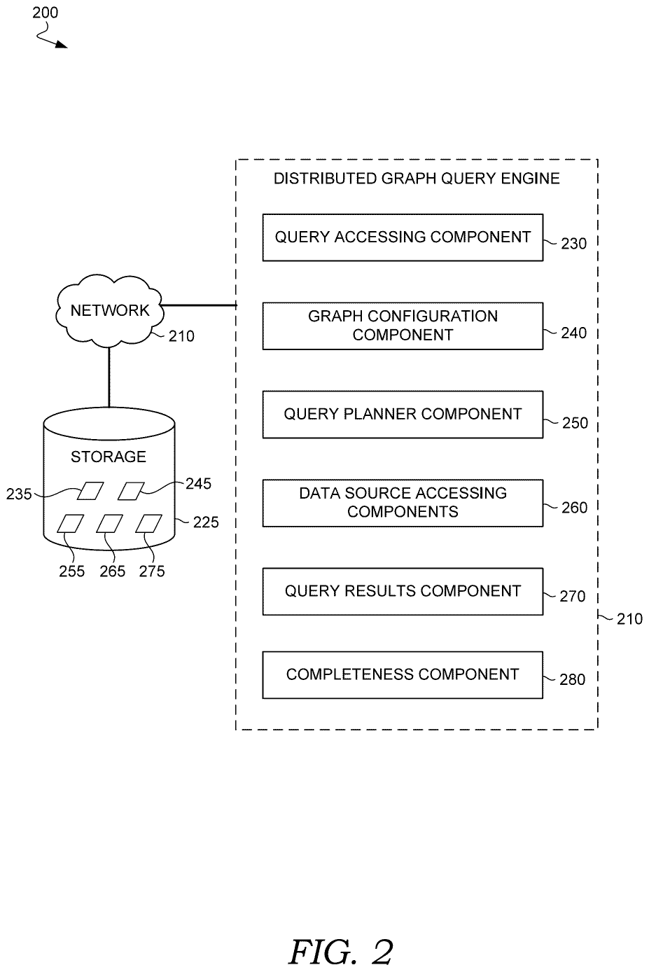

Data sources 104a and 104b through 104n may comprise data sources and/or data systems, which are configured to make data available to any of the various constituents of operating environment 100 or system 200 described in connection to FIG. 2. For instance, in one implementation, one or more data sources 104a through 104n provide (or make available for accessing), to graph configuration component 240 of FIG. 2, data through data source accessing components 260 to generate a graph metaphor of graph configuration component 240 representing data sources 104a through 104n through plug-ins for each of the data sources of data source accessing components 260, such as rest APIs, SQL database plug-ins, graph database plug-ins, search engine plug-ins, and/or any other plug-in for any type of data source. In one implementation, one or more data sources 104a through 104n provide (or make available for accessing), to query results component 270 of FIG. 2, data through data source accessing components 260 by executing distributed queries of the query candidates through plug-ins for each of the data sources of data source accessing components 260, such as rest APIs, SQL database plug-ins, graph database plug-ins, search engine plug-ins, and/or any other plug-in for any type of data source. In one implementation, completeness criteria of data sources 104a through 104n are calculated using a completeness component 280, as described herein. Data sources 104a and 104b through 104n may be discrete from user devices 102a and 102b through 102n and server 106 or may be incorporated and/or integrated into at least one of those components.

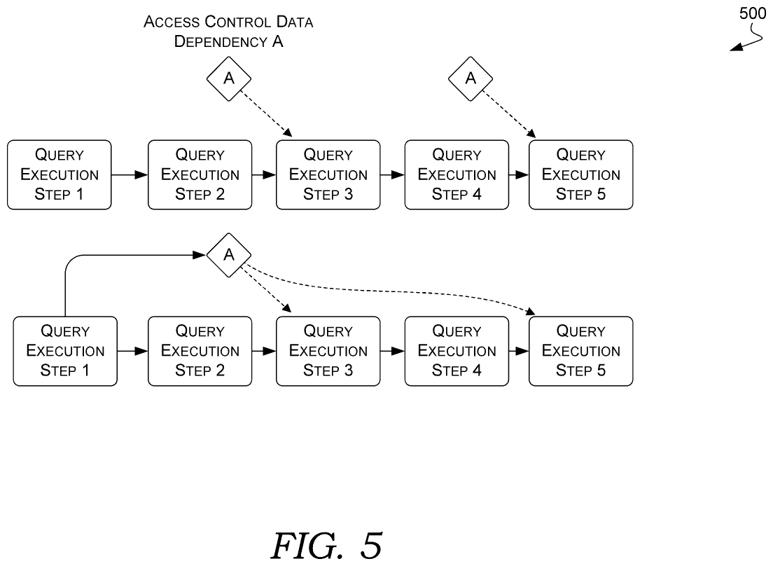

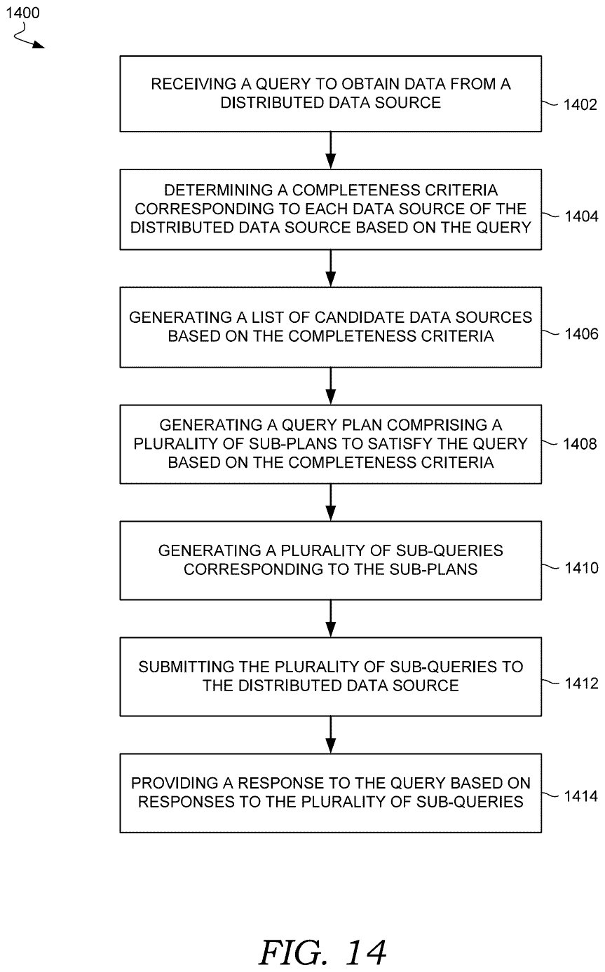

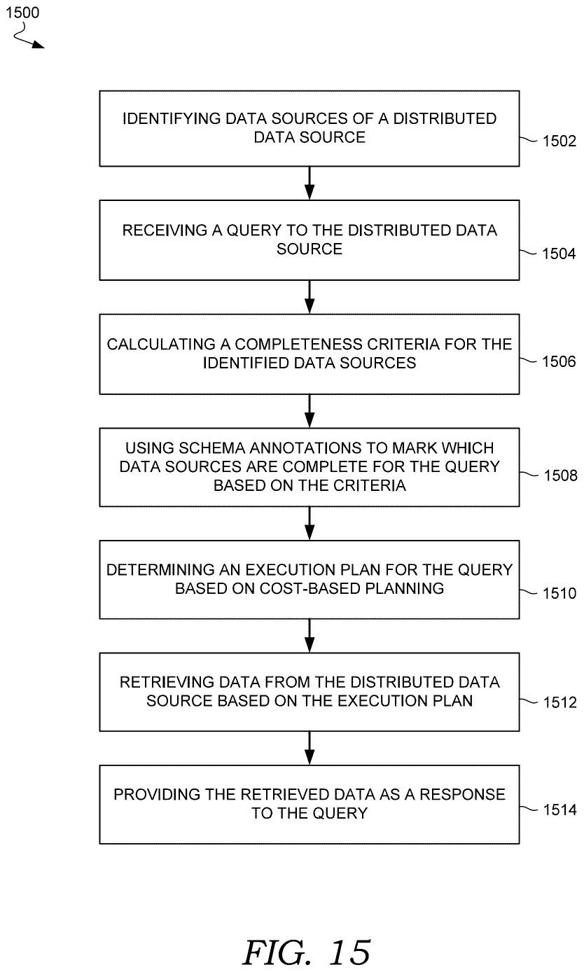

Operating environment 100 can be utilized to implement one or more of the components described in connection with FIGS. 2-4. Operating environment 100 can be utilized to implement one or more of the operations and/or systems described in connection with FIGS. 5-13. Operating environment 100 can also be utilized for implementing aspects of methods described in connection with FIGS. 14-15.

Referring now to FIG. 2, with continuing reference to FIG. 1, a block diagram is provided showing aspects of an example computing system architecture suitable for an implementation of the technologies provided in this disclosure and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200, including distributed graph query engine 210, and storage 225. Distributed graph query engine 210 communicatively couples components of system 200 including query accessing component 230, graph configuration component 240, query planner component 250, data source accessing components 260, and query results component 270, which may be embodied as a set of compiled computer instructions or functions, program modules, computer software services, or an arrangement of processes carried out on one or more computer systems, such as computing device 1600, described in connection to FIG. 16, for example.

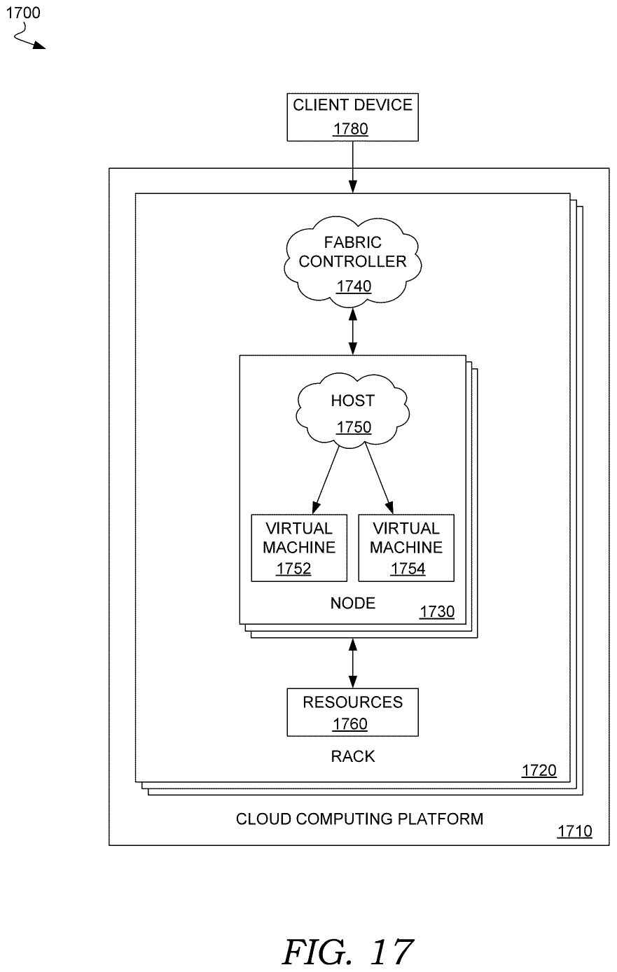

In one implementation, the functions performed by components of system 200 are associated with one or more computer applications, services, or routines, such as a search application. The functions may operate to programmatically distribute graph queries of a graph metaphor of distributed data sources, or otherwise to provide an enhanced computing experience for the user. In particular, such applications, services, or routines may operate on one or more user devices (such as user device 102a) or servers (such as server 106). Moreover, in some implementations, these components of system 200 may be distributed across a network, including one or more servers (such as server 106) and/or client devices (such as user device 102a) in the cloud, such as described in connection with FIG. 17, or may reside on a user device, such as user device 102a. Moreover, these components, functions performed by these components, or services carried out by these components may be implemented at appropriate abstraction layer(s) such as the operating system layer, application layer, hardware layer, or other layers of the computing system(s). Alternatively, or in addition, the functionality of these components and/or the implementations described herein can be performed, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc. Additionally, although functionality is described herein with regard to specific components shown in example system 200, it is contemplated that in some implementations, functionality of these components can be shared or distributed across other components.

Continuing with FIG. 2, query accessing component 230 is generally configured to access or receive a query, such as through user device 102a through 102n of FIG. 1. In some implementations, data source accessing components 260 may be employed to facilitate the accessing of a query for query planner component 250. The data may be received (or accessed), and optionally reformatted, and/or combined, by query accessing component 230 and stored in one or more datastores such as storage 225, where it may be available to other components of system 200.

Some implementations of query accessing component 230 utilize query accessing logic 235 stored in storage 225 to access or receive a query. In particular, utilizing query accessing logic 235 may comprise computer instructions including rules, conditions, associations, classification models, or other criteria for, among other operations, accessing or receiving a query. Query accessing logic 235 may take different forms, depending on the particular information items being determined, extracted, and/or processed. For example, query accessing logic 235 may comprise a set of rules, such as Boolean logic, various decision trees (for example, random forest, gradient boosted trees, or similar decision algorithms), conditions or other logic, fuzzy logic, neural network, finite-state machine, support vector machine, machine-learning techniques, such as a language model, or combinations of these to access or receive (or facilitate accessing or receiving) queries.

Continuing with FIG. 2, graph configuration component 240 is generally responsible for generating a graph metaphor representing a plurality of data sources 104a-104n of FIG. 1, such as distributed databases, datastores, services, applications, and/or others. Implementations of graph configuration component 240 generate a graph metaphor based on data collected by data source accessing components 260. The graph metaphor generated by graph configuration component 240 can be accessed by query planner component 250. The graph metaphor generated by graph configuration component 240 may be stored in storage 225, where it may be used by other components or subcomponents of system 200.

Implementations of graph configuration component 240 may generate a graph metaphor representing a plurality of data sources 104a-104n of FIG. 1. In this regard, each data source of data sources 104a-104n of FIG. 1 can be optimized to store different types of data. The graph metaphor generated by graph configuration component 240 models entities of the plurality of data sources and relationships between the entities to provide semantic connections between the data of the plurality of data sources to abstract complex relationships into a more manageable form for graph-based operations without sacrificing the optimization of each of the plurality of data sources 104a-104n. In some implementations, the graph metaphor generated by graph configuration component 240 corresponds to a federated logical graph representing heterogeneous stores of a federated database system.

The graph metaphor generated by graph configuration component 240 includes nodes representing entities of the plurality of data sources (for example, heterogeneous stores of a federated database system) and edges representing relationships between the nodes. The graph metaphor generated by graph configuration component 240 stores properties of the nodes and edges based on a corresponding type of entity and type of relationship, respectively. The node properties include descriptive attributes describing the entity, such as metadata indicating name and data source location of the entity, and/or query properties indicating constraints when querying the entity. In this regard, for a node representing data of a data source 104a of FIG. 1, only the node properties are stored in the graph metaphor generated by graph configuration component 240 while the data itself (for example, the content) is stored in the data source 104a of FIG. 1. The edge properties include descriptive attributes describing the relationship, such as metadata indicating a time when the relationship was created, and/or query properties indicating constraints when querying the edge, such as through an edge traversal. Examples of query properties include an indication of available identifiers that can be used to query an entity, such as the type of descriptive identifier supported by a data source; an indication of available query functions, such as whether the entity can support edge traversal, a lookup of a node by ID, a search function, and/or any other query function; access requirements, such as requiring a call to a security service to confirm access to data for the user; and/or any other properties that indicate constraints when querying.

Some implementations of graph configuration component 240 utilize graph configuration logic 245 stored in storage 225 to generate a graph metaphor. In particular, graph configuration logic 245 may comprise computer instructions including rules, conditions, associations, classification models, or other criteria for, among other operations, generating a graph metaphor. Graph configuration logic 245 may take different forms, depending on the particular information items being determined, extracted, and/or processed. For example, graph configuration logic 245 may comprise a set of rules, such as Boolean logic, various decision trees (for example, random forest, gradient boosted trees, or similar decision algorithms), conditions or other logic, fuzzy logic, neural network, finite state machine, support vector machine, machine-learning techniques, such as a language model, or combinations of these to generate (or facilitate generating) a graph metaphor.

Continuing with FIG. 2, query planner component 250 is generally responsible for determining a query plan. Implementations of query planner component 250 may determine a query plan based on the query accessed by query accessing component 230 and the graph metaphor generated by graph configuration component 240. Implementations of query planner component 250 use completeness criteria obtained from completeness component 280, as described below, for determining a query plan. Thus, information about the query accessed by query accessing component 230, and the graph metaphor generated by graph configuration component 240, can be accessed by query planner component 250 in storage 225. The data of the query plan generated by query planner component 250 may be stored in storage 225, where it may be used by other components or subcomponents of system 200.

Implementations of query planner component 250 may access or receive a graph query and parse the graph query to determine a representation of query candidates from the graph metaphor generated by graph configuration component 240. The query candidates correspond to entities, such as data sources and/or regions of the federated database system, and/or relationships that are queried by data source accessing components 260 in order to determine a response to the graph query for presentation by query results component 270. The entities are chosen based on completeness criteria obtained from completeness component 280, as described below, to determine a response to the graph query for presentation by query results component 270, in order to determine a response to the graph query for presentation by query results component 270. For example, a user inputs a query for data, and the query is accessed by query accessing component 230. A query is applied to the graph metaphor generated by graph configuration component 240 as a graph query utilizing any known graph querying technique. The representation of query candidates corresponding to each node and/or edge of the graph metaphor of graph configuration component 240 that are queried in order to determine a response to the graph query is determined by query planner component 250. The selection of which query candidates to use to determine a response to the graph query is determined based on completeness criteria from completeness component 280.

The query properties of each of the query candidates are used to determine a query plan by query planner component 250. The query plan determined by query planner component 250 includes a set of query steps to be performed in order to query each of the query candidates, which are selected based on completeness criteria. A query plan is determined by query planner component 250 based on the set of query steps that are determined based on the completeness criteria. The query plan is executed by executing distributed queries of the query candidates by data source accessing components 260 through plug-ins for each of the data sources 104a-104n of FIG. 1. Additional examples of programmatically distributing graph queries of a graph metaphor of distributed data sources are described herein at least in connection with FIGS. 3-11.

In some implementations, the query plan is determined by query planner component 250 based on completeness, latency, cost, reliability, and/or other similar factors, such as through statistics, rules, and/or heuristics. In some implementations, a machine learning model is used by query planner component 250 to determine the query plan based on available metrics, such as expected performance gain due to distribution and/or parallelization of the query, the cost in terms of CPU utilization, memory consumption, or computational cost, statistics on how frequently the result of executing the access control logic is positive, completeness, and/or any other factors.

Some implementations of query planner component 250 utilize query planner logic 255 stored in storage 225 to determine a query plan. In particular, query planner logic 255 may comprise computer instructions including rules, conditions, associations, classification models, or other criteria for, among other operations, determining a query plan, or any of the implementations described herein. Query planner logic 255 may take different forms, depending on the particular information items being determined, extracted, and/or processed. For example, query planner logic 255 may comprise a set of rules, such as Boolean logic, various decision trees (for example, random forest, gradient boosted trees, or similar decision algorithms), conditions or other logic, fuzzy logic, neural network, finite-state machine, support vector machine, machine learning techniques, or combinations of these to determine (or facilitate determining) a query plan according to implementations described herein.

Continuing with FIG. 2, data source accessing components 260 are generally responsible for accessing each of the data sources 104a-104n of FIG. 1 used to generate the graph metaphor of graph configuration component 240. Implementations of data source accessing components 260 receive instructions to access data from each of the data sources 104a-104n by query planner component 250 and/or graph configuration component 240, based on completeness criteria obtained from completeness component 280. Thus, information regarding a query plan generated by query planner component 250 may be accessed by data source accessing components 260 in storage 225. The data accessed from data sources 104a-104n of FIG. 1 by data source accessing components 260 may be stored in storage 225, where it may be used by other components or subcomponents of system 200.

Implementations of data source accessing components 260 may access data stored in data sources 104a-104n in order to execute the distributed queries of the query plan determined by query planner component 250 through adaptors and/or plug-ins for each of the data sources 104a-104n of FIG. 1.

Some implementations of data source accessing components 260 utilize data source accessing logic 265 stored in storage 225 to access data sources 104a-104n of FIG. 1. In particular, data source accessing logic 265 may comprise computer instructions including rules, conditions, associations, classification models, or other criteria for, among other operations, accessing data sources 104a-104n of FIG. 1. Data source accessing logic 265 may take different forms, depending on the particular processing of accessing data sources 104a-104n of FIG. 1. For example, data source accessing logic 265 may comprise a set of rules, such as Boolean logic, various decision trees (for example, random forest, gradient boosted trees, or similar decision algorithms), conditions or other logic, fuzzy logic, neural network, finite-state machine, support vector machine, machine learning techniques, or combinations of these to access data sources 104a-104n of FIG. 1 according to implementations described herein.

Continuing with FIG. 2, query results component 270 is generally responsible for determining a query result from the distributed queries of each of the data sources 104a-104n of FIG. 1 by data source accessing components 260 through the query plan of query planner component 250 based on completeness criteria, as described herein. Implementations of query results component 270 may determine a query result based on data accessed by data source accessing components 260. Thus, information regarding the data accessed by data source accessing components 260 may be accessed by query results component 270 in storage 225. The data generated by query results component 270 may be stored in storage 225, where it may be used by other components or subcomponents of system 200.

Implementations of query results component 270 may determine a query result from the distributed queries of each of the data sources 104a-104n of FIG. 1 by data source accessing components 260 through the query plan of query planner component 250. For example, the results from execution of each of the distributed queries are combined by query results component 270, such as through a conflate operation and/or deduplicating redundant data. The query result is then presented to the user by query results component 270 in response to the query through a display screen of a user device, such as user devices 102a-102n of FIG. 1.

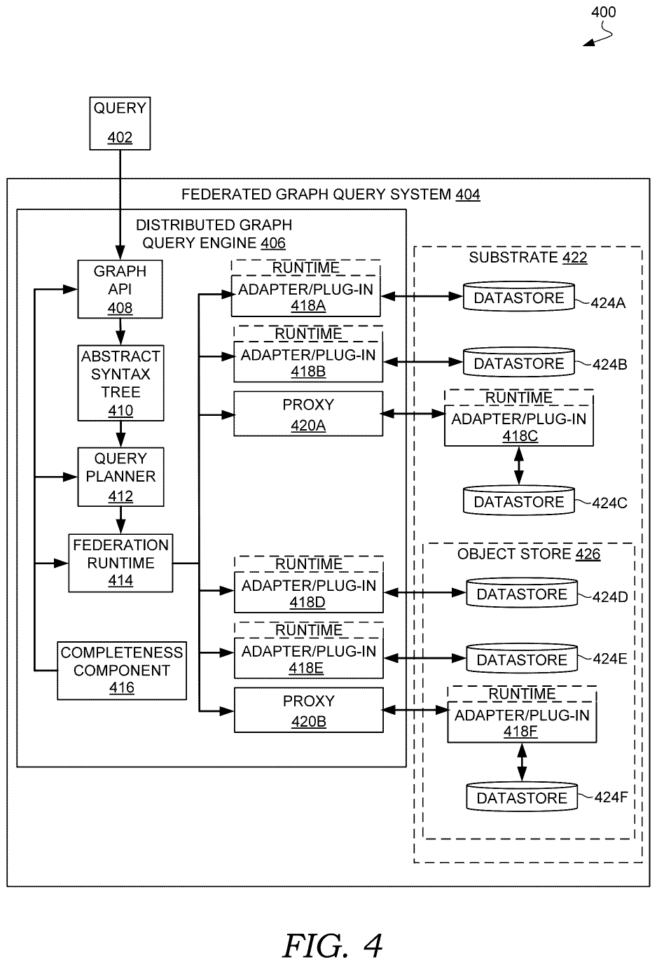

Continuing with FIG. 2, completeness component 280 is generally responsible for determining completeness criteria for each of the data sources 104a-104n of FIG. 1. Completeness criteria from completeness component 280 is used by query planner component 250 to determine which of data sources 104a-104n of FIG. 1 to use to obtain the results from execution of each of the distributed queries, as described herein. The completeness criteria obtained from completeness component 280 is balanced against other factors to determine the best plan to obtain the data efficiently. For example, one data source of the data sources 104a-104n of FIG. 1 can contain all of the data necessary for responding to query (described herein as “COMPLETE”) but could be very slow to access while another data source of the data sources 104a-104n of FIG. 1 might contain only a part of the data necessary for responding to the query (described herein as “INCOMPLETE”) but could be very fast. The query planner component 250 could generate a plan based on the completeness criteria to retrieve some of the data from the fast data source that is INCOMPLETE and obtain the rest of the data from the slow data source that is COMPLETE. Additional details on the completeness component 280 are described below in connection with FIG. 4.

With reference now to FIG. 3, FIG. 3 is a block diagram 300 illustrating programmatically distributing graph queries of a graph metaphor of distributed data sources, in accordance with an implementation of the present disclosure. The diagram 300 shown in FIG. 3 can be utilized to programmatically distribute graph queries of a graph metaphor of distributed data sources, such as described in connection with the components of system 200 of FIG. 2.

As shown in FIG. 3, diagram 300 shows an example distributed graph query engine 304 capable of collecting disconnected semantically linked data into a single coherent graph abstraction through schema 310 using completeness, as described herein. Generally, schema 310 (for example, a graph metaphor generated by graph configuration engine 240 of FIG. 2) describes the connectedness of the graph and pointers to individual stores of stores 314 (for example, data sources 104a-104n of FIG. 1), and each entity in the graph is stored in a partially overlapping number of datastores such as datastores 314 (also referred to herein as stores). Generally, each runtime of runtimes 312 (for example, data sources accessing components 260 of FIG. 2) includes a collection of retrieval adapters or plug-ins and is capable of returning the respective store data. Generally, scheduler 308 is capable of transforming a query 302 as received by graph API 306 (for example, query accessing component 230 of FIG. 2) into a collection of retrieval operations to individual datastores 314 based on schema 310. Not shown in FIG. 3, but described in connection with FIG. 4, the runtimes of runtimes 312 can also include proxies, which form an additional interface between the scheduler 308 and the datastores 314.

Schema 310 is a component that describes the logical layout and interconnectedness of the distributed data that together constitutes the single logical graph. In addition to describing which data can be found in the various services/stores, it also captures concepts such as which identifiers can be used to query said data, which query capabilities exist (edge traversal, lookup of a node by ID, search, or the like), and which subset of data is included in each of the datastores 314 (datastore A, datastore B, datastore C, and/or datastore D). Schema 310 can capture implicit data dependencies such as security context or other access tokens. Schema 310 can capture existing patterns for describing delegate access requirements more explicitly, making it possible to describe under which circumstances access control logic dependencies should be satisfied, including, for example, completeness obtained by completeness component 316. For example, a single store might support retrieval of a multitude of different node/edge types along with a plethora of properties for these. Access control logic dependencies might be relevant only for a subset of these node/edge types and/or properties, and the schema can encode this. Similarly, different datastores of datastores 314 can be faster or slower and can be more or less complete, enabling completeness criteria to be used to determine the query plans and sub-plans for execution by the scheduler 308. Some of these logic dependencies might be conditional and encoded onto the data through specific property values.

An example of a schema declaration of token data dependency of schema 310 includes as follows:

[SchemaEndpoint(StorageTag=“MyStore”, TokenDependency=“GMT”)]
public class MyStoreSchemaDefinition
{
. . . Schema Contents for MyStore . . .
}

In this example, the store/service has a token (data) dependency on a specific token named GMT. It should be noted that the same TokenDependency syntax can be applied to nodes, edges, and properties.

Another example of a schema declaration of logic dependency for a specific node type of schema 310 includes as follows:

```
[SchemaEndpoint(StorageTag=“MyStore”)]
public class MyStoreSchemaDefinition
{
  [SchemaEntity(ResolvedBy=“ResolvingStore.ResolvingMethod”, . . . )]
  public Document Document { get; set; }
}
```

In this example, the Document entity (a node) has an access control logic dependency, ResolvingMethod, that can be found in the ResolvingStore service.

Another example of a schema declaration of logic dependency for a specific edge type of schema 310 includes as follows:

```
[SchemaEndpoint(StorageTag=“MyStore”)]
public class MyStoreSchemaDefinition
  [SchemaRelationship(ResolvedBy=“Store.Method”, . . . )]
  public ViewRelationship View { get; set; }
}
```

In this example, the View relationship (an edge) has an access control logic dependency, “Method,” that can be found in “Store.”

Another example of a schema declaration of logic dependency for a specific property of schema 310 includes as follows:

```
public class Document
{
  [SchemaProperty(ResolvedBy=“SecurityService.TrimContent”, . . . )]
  public string Text { get; set; }
}
```

In this example, the Text property of the Document node type has an access control logic dependency, TrimContent, that can be found in the SecurityService. In some implementations, this pattern could be used to declare an access control logic dependency for a property present on an edge.

One example of a schema declaration of logic dependency dependent on runtime conditional of schema 310 includes as follows:

```
public class Document
{
  [SchemaProperty( . . . )]
  public bool NeedsExtraTrim { get; set; }
    . . .
}
[SchemaEndpoint(StorageTag=“MyStore”)]
public class MyStoreSchemaDefinition
{
[SchemaEntity(ConditionalResolvedBy=“ResolvingStore.
ResolvingMethod”,
      ConditionalResolvedWhen(this.Document.NeedsExtraTrim ==
true))]
  public Document Document { get; set; }
}
```

In this example, the NeedsExtraTrim property in the Document class is a Boolean value encoding whether extra access control business logic should be executed or not. The Document entity itself of the store schema definition is annotated to capture which access control logic should be executed (ResolvingStore.ResolvingMethod), and under which conditions this should happen (this.Document.NeedsExtraTrim true). In some implementations, the condition under which this extra trimming should occur can be expressed in C#code. In some implementations, any conditional can be expressed, including conditions over multiple properties and execution of methods and library functionality and other means of declaring the conditionals that could be used, such as declaration in different languages, pointer to functions, value indicating one or multiple hardcoded conditions, and/or others.

Arbitrary policies on conditioned access control of a graph object can be expressed. In some implementations, a differential private aggregate operation is included over a set of objects that requires that the sample size be larger than a threshold value X for it to be considered anonymous. For example, a policy can then be expressed as a predicate that counts the sample size:

[SchemaEntity(ConditionalResolvedBy=“ResolvingStore.
ResolvingMethod”,
ConditionalResolvedWhen( count(this.Document) <= X)]
public Document Document { get; set; }

In this regard, an access control mechanism can be contingent on the sample size of a “Document” collection. This requires compilation to enforce a policy stating the obligatory presence of an aggregation operation in the query plan itself.

Continuing with FIG. 3, scheduler 308 transforms an input query to the sequence of discrete steps that are performed to fulfill the query intent. Scheduler 308 leverages schema 310 to identify which stores/services 314 should be queried for data, and in which order this should happen. Scheduler 308 also uses completeness data obtained from completeness component 316, which queries 318 each of the datastores 314 for completeness, as described herein. Additional details of completeness component 316 are described below in connection with FIG. 4. Although not illustrated in FIG. 3, scheduler 308 and schema 310 are elements of a query planner such as query planner 412, described in connection with FIG. 4.

An example of determining distributed queries by scheduler 308 by parallel fetching of property data includes as follows:

MATCH (document:File) WHERE document.Id = ‘<my id>
RETURN document.PropertyA, document.PropertyB

In this example, the query is referencing a single node (document) by its ID, and retrieves two properties for this node. PropertyA originates from one datastore while PropertyB originates from a second datastore. In order to satisfy the request, both datastores should be interrogated and the results combined to form the final result. These data fetch operations can be executed in parallel.

An example of determining distributed queries by scheduler 308 by parallel traversal of paths in the graph includes as follows:

MATCH (me:Me)-[:MODIFIED|MENTIONED_IN]->(doc:File)
RETURN doc.Title

In this example, the query is anchored in a single node (me), and two edge types are followed to get to a set of documents (doc) for which the Title property is returned. The MODIFIED edge is served from one datastore, and the MENTIONED_IN edge is served from a second datastore. In order to satisfy the request, both datastores should be interrogated and the results combined to form the final result. These data fetch operations can be executed in parallel.

An example of determining distributed queries by scheduler 308 by parallel lookups followed by a union/join includes as follows:

MATCH (wordDocs:File) WHERE wordDocs.Id in $wordDocIds LIMIT 3
RETURN wordDocs.Title
UNION
MATCH (excelDocs:File) WHERE excelDocs.Id in $excelDocIds LIMIT 3
RETURN excelDocs.Title

In this example, the query performs two separate lookups, one for Word documents and another for Excel files, before the union of the result sets is constructed and returned to the caller. The Word documents are served from one datastore, and the excel files from the second datastore. In order to satisfy the request, both datastores should be interrogated and the results combined to form the final result. These data fetch operations can be executed in parallel.

An example of determining distributed queries by scheduler 308 by multiple anchors includes as follows:

MATCH (me:Me)-[r1:MODIFIED]->(doc:File)<-[r2:MENTIONED_IN]-
(person)
WHERE id(person) = “<UserId>”
RETURN doc.Title

In this example, this query fetches the respective edges from two separate stores. However, this query pattern exposes two separate starting points. In a sequential plan, the query can either start (anchor) using the Me entity, or start using the identifier expressed in the person ID predicate. A query plan can choose to start at both possible anchors and then perform a joint operation (conflate) on the common result found in the middle variable denoting the file entity. Depending on the individual cardinality of the individual edge types, a query plan may invoke more lookups than a sequential if the number of edges in r2 is greater than r1.

In some implementations, the distributed logical graph of schema 310 spans a plethora of different datastores with different capabilities, data, levels of completeness, and dependencies that should be satisfied in order to serve requests while performing access control checks. As an example, some of the stores in the ecosystem rely on up-front access control where data is trimmed according to access controls prior to being stored in the user's partition. For these stores, no access control is performed at query time, other than verifying that the caller indeed is the owner of the partition, such as through an actor token. Other stores, on the other hand, are tenant-wide, and the access control evaluation is applied at query time. To perform this check, the security context (for example, a token containing the security group memberships and access rights of the user) of the calling user is compared to the access controls of the individual data items to be returned. Data inaccessible to the user is trimmed away and never leaves the store.

An example of determining distributed queries by scheduler 308 through access control dependencies includes as follows:

MATCH (me:Me)-[:COLLABORATES_WITH]-(user)-[:MODIFIED]-
>(doc:File)
RETURN doc.Title

In this example, Store A is capable of serving the COLLABORATES_WITH edge, and is of the user-partitioned kind requiring only an actor token. Store B is capable of serving the MODIFIED edge, and is of the tenant-wide variety requiring the calling user's security context. Both stores are capable of serving sufficient data to support federation between the two datastores (for example, IDs of the nodes can be resolved between the two).

Generally, the calling user is identified when performing a query and the actor token is available. As the second system should be interrogated to retrieve the MODIFIED edges, the security context of the caller should be obtained. When retrieving security context is considered separate from the graph query execution itself and is offloaded to the caller, the abstraction of a single logical graph is broken, as the caller may both understand and explicitly handle the different requirements of the various stores.

Here, scheduler 308 determines the distribution of queries by executing the fetching of the security context in parallel with the first part of the query-(me: Me)-[: COLLABORATES_WITH]-(user)—which also acts as a data dependency to the second part of the query. In this regard, scheduler 308 can automatically identify such access control-related data dependencies and apply parallelism to speed up query execution. Additionally, the query execution can be more easily monitored and managed, as the tokens are tracked as part of the query execution. In this regard, issues that may arise during the execution can be identified and addressed. In addition, modeling the tokens as data dependencies, the query execution can be more secure, as the tokens are not exposed to the callers, thus reducing the risk of malicious actors gaining access to sensitive information. Another benefit of this approach is that developer agility can be increased, as cognitive load and the number of integration points that the callers relate to is reduced.

Another example of determining distributed queries by scheduler 308 through access control dependencies includes as follows:

MATCH (me:Me)-[:ACCESSED]->(sensitiveDoc:SensitiveFile)<-
[:MODIFIED]-(user)
RETURN sensitiveDoc.Title, user.Name

In the previous example, parallelism is applied to access control data dependencies. In this example, parallelism is applied to a different type of access control dependency, namely logic that can be executed to identify whether a result indeed is accessible to the caller. In some implementations, these techniques can be performed without applying parallelism. In this example, determining whether or not access can be granted to the (sensitiveDoc) nodes actually requires two distinct operations: (1) Reading up the files from storage system A, which would include executing any built-in access control checks of storage system A, and (2) For each of the files, executing a secondary call to a separate access control service that will determine whether or not the file indeed can be accessed. This call requires the security context of the calling user.

The two operations can occur due to increasingly fine-grained access controls that are highly context-sensitive (for example, this data can only be accessed from the corporate network and/or within working hours). When these are combined with user-partition-based storage systems, there might be cases where a data item is present in the user's partition because they generally have access to it, but these policies should be evaluated at query time.

Continuing with the example, the ACCESSED edges and (sensitiveDoc) nodes can be read from storage system A. MODIFIED edges and (user) nodes can be read from storage system B. Both stores are capable of serving sufficient data to support federation between the two (for example, IDs of the nodes can be resolved between the two).

Similar to the previous example, retrieving the caller's security context can be executed in by reading the ACCESSED edges and (sensitiveDoc) nodes from store A. Following this initial part of the query, store B should be queried to retrieve the MODIFIED edges and (user) nodes. However, it is also necessary to determine whether the caller actually has access by interrogating the access control service. This, however, can happen in parallel with the call to service B. In this regard, parallelism can be implemented by scheduler 308 by pursuing parallel execution paths and ensuring the access control determination from any access control logic is respected.

Continuing with FIG. 3, runtime 312 is responsible for executing the compiled query plan from scheduler 308. Runtime 312 can perform operations of interpreting, executing, and evaluating the results from the individual query plan steps (for example, query results component 270 of FIG. 2).

In some implementations, for automatic parallel graph query execution, scheduler 308 identifies which steps are independent of each other and transforms the original sequential graph execution plan into a parallel one based on these dependencies. In some implementations, scheduler 308 can execute the original sequential graph execution plan. In order to parallelize a sequential plan, scheduler 308 takes each step of the sequential plan, and considers each as pure functions with inputs and outputs. Scheduler 308 can then identify what is output and what is mutated based on the input. For example, in some implementations, for store A and store B, a scheduler 308 determines whether queries can be run in parallel if (1) the input of store A does not intersect with the output of store B; (2) the input of store B does not intersect with the output of store A; (3) none of the input in store A is mutated in store B; and (4) none of the input in store B is mutated in store A. In this regard, in some implementations, if all of the aforementioned cases hold, scheduler 308 merges these two discrete sequential steps into one parallel step for the runtime to execute in parallel.

In some implementations, in the case of data dependencies, the query execution plan determined by scheduler 308 includes a backward dependency. For example, the data (token) is not explicitly mentioned in the query text but inferred from the schema 310 at query planning time. In some implementations, the same dependency can be introduced by multiple parts of the same query. In some implementations, scheduler 308 performs a forward pass to identify all data/token dependencies. Following this, scheduler 308 performs a secondary reverse pass, and the token dependency is propagated backwards towards the beginning of the plan such that parallelism can be leveraged, and duplicate token fetch operations are collapsed. In some implementations, scheduler 308 continues propagating the resolution of data dependencies as far as possible. In some implementations, scheduler 308 propagates the token fetch operation to happen just in time to satisfy the first usage.

In some implementations, executing access control logic can happen in parallel with fetching data for a specific data item. In this regard, four scenarios can occur based on the order the results (data fetch or access control logic execution) are returned to the query execution engine: (1) Data is returned first, and following this a positive response from the access control logic is returned. In this case, the data can be leveraged further in the query execution; (2) Data is returned first, and following this a negative response from the access control logic is returned. In this case, the data cannot be leveraged further in the query execution; (3) a positive response from the access control logic is returned first, and this is followed by the data. In this case, the data can be leveraged further in the query execution; and (4) a negative response from the access control logic is returned first, and this is followed by the data. In this case, the data cannot be leveraged further in the query execution.

In this regard, in some implementations, in order to support parallel execution of data fetch and access control logic execution, any data subject to this execution mode remains “locked” until a positive access control logic response has been received. In this regard, a sandbox abstraction is used to house data that would fall within this class. For example, the sandbox provides access to its data through a simple get-interface. The sandbox implementation is responsible for validating that a positive access control logic determination has been received, and in the case where it has not, it will deny access and not return any data. An example of code for a sandbox implementation is as follows:

```
1 reference
public class Sandbox : ISandbox
{
  0 references
  public Sandbox(IDataFetch dataFetch, IAccessControlLogic[ ]
      accessControlLogicInvocations)
  {
    this.data = data = dataFetch.FetchData( );
    this.accessGranted = false;
    foreach (var accessControlLogic in
        accessControlLogicInvocations)
    {
      var accessGrantedTmp = accessControlLogic.Invoke( );
      if (accessGrantedTmp == false)
      {
          return
      }
      }
    // All access control invocations successful
    this.accessGranted = accessGrantedTmp;
  }
  0 references
  public IValue GetData( )
  {
    if (this.accessGranted)
    {
      return this.data;
    }
    return NoAccessSentinel;
  }
}
```

In this example, if access turns out to not be granted to a data item, the query execution engine should update its state by invalidating the path through the graph. In some implementations, in the case of access control logic that should be invoked conditionally, two options are available: (1) Execute the access control logic sequentially after evaluating the condition to be true, and (2) Execute the access control logic in parallel with fetching data and evaluating the condition. In some implementations, the decision can also be made at query planning time based on statistics and rules/heuristics over these. In some implementations, a machine-learning model can make this decision based on available metrics, such as expected performance gain due to distribution and/or parallelization, the cost in terms latency and/or computational resources such as CPU utilization, memory consumption, energy consumption, computational cost, statistics on how frequently the result of executing the access control logic is positive, and/or others.

With reference now to FIG. 4, FIG. 4 is a block diagram 400 illustrating an example federated graph query system 404 capable of collecting disconnected semantically linked data into a single coherent graph abstraction, using completeness, in accordance with an implementation of the present disclosure. As described above, a federated graph query system 404 compiles and executes queries over a virtual graph distributed over multiple physical storage systems. Systems that use the federated graph query system 404, not shown in FIG. 4, are often backend services or front-end applications that use relational data stored in the physical storage systems. These systems generate requests for structured data that may be expressed in any compatible declarative query language, including, but not limited to, GraphQL, KQL, SQL, or Cypher. Queries typically have high variability that stems from the fact that a query can be written to combine any set of entities, edges and properties with any set of predicates, given that the query follows the public store configuration, described below. Such queries can also follow looping patterns such as, for example, repeatedly following an edge until some condition or conditions are met.

The term completeness is used to indicate, at a basic level, such that any mismatch between the expected output of a query and the actual output indicates a lack of complete data representation, or a lack of completeness. More specifically, completeness is based on two principles. The first principle is that the complete representation of data in an access-controlled federated graph is user-dependent. Typically, a user will not have access to all the data that exists in the world, or even all the data that exists within their tenant. Some data in a tenant will be public, such that anyone can access it, and other data will be private and scoped to a single user, or a small subset of users. The inability to access data that the user does not have access to does not thus constitute a lack of completeness. For example, consider the private chat/email correspondence of a user A. The fact that this correspondence is not available for another user B is not considered a lack of completeness, because user B does not have access to the emails of user A unless actions dictate otherwise. Moreover, the same user dependence applies to data that is subject to discretionary access control mechanisms such as that for files, and information barriers applied to other users. The second principle is that the most complete representation in the access controlled federated graph is considered complete. In other words, completeness of a graph is based on the best effort. So, for example, if there exists some “most complete” datastore for a specific data item, then that datastore is considered to be complete regardless of whether it is globally complete or not. This best-effort principle is usable because the notion of completeness is most valuable as an optimization criterion rather than as an absolute criterion. For example, consider a case where modifications to documents are made by users. While it is possible that thousands of people may have modified the same document, the “most complete” view that can be accessed through a federated graph query system 404 may only expose the last thousand (N<=1000) user modify actions for a given document and datastore. During query planning, this set of exposed modifications is considered complete from the query execution planning view when the anchoring node is the document. At the same time, the federated graph query system 404 can also expose a datastore that, given a user A, contains the last two-thousand (M<=2000) modifications that user A has made. Deciding which of these two stores would be considered “most complete” depends on the anchoring point in that it is query-dependent, depending on the document.

In some implementations, given a datastore, such as datastore 424A-F, two primary techniques can be used to mark or tag data with respect to completeness. The datastores and data can have an associated completeness criteria (also referred to herein as a completeness measure). The associated completeness criteria of a datastore or a data item is defined by one or both of the following measures, which can be used interchangeably, or combined together, given that their relative ordering can be defined. The first measure is binary, where a datastore or data item is either COMPLETE or INCOMPLETE. These values can be defined as binary numbers where COMPLETE is one and INCOMPLETE is zero, so that COMPLETE>INCOMPLETE. The second measure is a gradient with, for example, values between 0.0 and 1.0. Here, 0.0 is equivalent to INCOMPLETE and 1.0 is equivalent to COMPLETE, and any value between indicates a degree of completeness. One mathematical definition of a completeness gradient measure is:

$$\frac{\vert {Set}_{1} \vert}{\vert ( {Set}_{1} ⋃ {Set}_{B 2} ⋃ … ⋃ {Set}_{N} ) \vert}$$

where |Set₁| is the set of data from a particular source (a datastore, for example) and |(Set₁∪Set_{B2}∪ . . . ∪Set_{N})| is the union of all sets of data. So, for example, if |Set₁| represents 25% of all data, then the completeness gradient measure for this set would be 0.25.

As described herein, the completeness component 416 calculates completeness criteria that is used by the query planner 412. In one implementation, completeness is calculated to ensure the most complete result set is returned from the federated graph query system 404 when multiple possible datastores are available.

In an implementation, using store-based completeness, an assumption is made that all of the data within a datastore is homogenously complete, meaning that each data type present in the store (in the store-specific configuration) has the same completeness. Under this assumption, it is possible to annotate each store with a completeness measure. In the query planning process, the query planner 412 can then prioritize stores with a higher measure of completeness. Under this assumption, the completeness of the datastore is set and the completeness of the execution plan is defined as the completeness of the least complete sub-plan.

In an implementation, using type-based completeness, the homogeneity assumption above is not made. As an example of non-homogeneity, consider a datastore that contains all files, but with only a subset of profiles of users that have interacted with the files. Without the above assumption, it can be assumed that different data types within a datastore can have different completeness measures. Using the above example, the datastore can be complete for file entities but incomplete (or partially complete in the case of gradient completeness) for profile entities. Here completeness measures are not calculated at the datastore level but are, instead, calculated for each data/schema type separately. This type-based completeness gives a more granular completeness measure for a particular datastore, as it has a completeness measure for each data type within the datastore. However, this type-based completeness does not consider relationships between types. For example, while a datastore can be considered complete for all files, this is only true if there is a relationship between a profile and the file. If this condition is not met, there is no guarantee that the file will be present in the datastore.

One method of guaranteeing completeness uses path completeness, where only files with an existing relationship between a profile and the file are present, and for such files, the datastore is complete. Then the completeness of the file entity depends on whether there is an edge pointing at it. This means that if a file is searched by ID, the datastore is incomplete, but if the file is searched by traversing a relationship from a profile, the datastore is complete. In some implementations, an INHERIT completeness label is used. As an example, consider:

[SchemaEntity(CompletenessLabel=CompletenessLabel.COMPLETE)]
Profile { }
[SchemaEntity(CompletenessLabel = CompletenessLabel.INHERIT)]
File { }
[SchemaRelationship(Tail=Person, Head=File),
CompletenessLabel.Complete]
MODIFIED { }

Here, where completeness is calculated, INHERIT will be treated as whatever came before it in the pattern. Thus, completeness is calculated by determining, at query time, what preceded a given schema type in the query pattern. Here, it is assumed that all entities are part of a single query path.

However, if it is not the case that all entities are part of a single query path, a completeness calculation is more complex. Consider a first query pattern (Person)-[:MODIFIED]→(File) that searches for a file based on a person and a second query pattern (File2) that is a simple file lookup. As there are two query paths to a same data type, the individual query pattern being executed will impact which schema entity the INHERIT trait will be applied to. Thus, this solution can result in inconsistently applied completeness metrics to the File entity so that a particular file might be inferred to be COMPLETE when that completeness is determined for the data types preceding it in the query execution. Here, the completeness measure can be further refined so that it is tied to a tuple of a data type and the circumstances under which that data type is retrieved/accessed. In some instances, circumstances are defined in terms of capabilities. As an example, consider:

```
File
{
  [QueryableBy(“fileById”,“id”,
      CompletenessLabel = CompletenessLabel.INCOMPLETE)]
  string fileId
}
[SchemaRelationship(Tail = Person, Head = File)]
[QueryableBy(“fileByEdge”, “relationshipName”,
    CompletenessLabel = CompletenessLabel.COMPLETE)]
MODIFIED { }
[SchemaRelationship(Tail = Person, Head = File)]
[QueryableBy(“fileByEdge”, “relationshipName”,
    CompletenessLabel = CompletenessLabel.COMPLETE)]
VIEWED { }
Profile
{
  [QueryableBy(“profileById”,“id”)]
  profileId
}
```

Here, how a caller can query for different entities and relationships is defined. The profileById capability can be used to fetch a profile given that its FileId is provided, and this tuple of data type (File) and circumstances under which it is retrieved (the capability profileByld) is annotated COMPLETE. When following the MODIFIED and VIEWED edges, the fileByEdge capability can be used to retrieve the complete set of edges with their corresponding files. For the File type, there are two possible ways of fetching it. First, filebyld can be used given a Fileld, but it can return an incomplete set of files. Alternatively, the fileByEdge capability can be used to traverse an edge to the file, which guarantees completeness in the case where the MODIFIED or VIEWED edges are used.

Pseudocode for an algorithm to calculate completeness using capabilities is:

```
foreach (var store in executionplan.stores)
{
  foreach (var capabilityInfo in store)
  {
    var capAnnotations =
      FindRelevantAnnotations(capabilityInfo);
    foreach (var capAnnotation in capAnnotations)
    {
      completenesslabel =
        FindLeastComplete(completenessLabel,
          capAnnotation.CompletenessLabel);
    }
  }
}
```

Here, within each datastore, all capabilities can be used and relevant configuration annotations can be fetched using the method FindRelevantAnnotations. The implementation of FindRelevantAnnotations depends on the implementation of a particular configuration. The implementation will find all QueryableBy annotations that match the capability name, and the property/relationship used in that capability. For example, if a capability spans across five different data types (entities, relationships and properties), five relevant annotations should be found. Once these annotations are found they can be iterated through to find the least complete one, as described above.

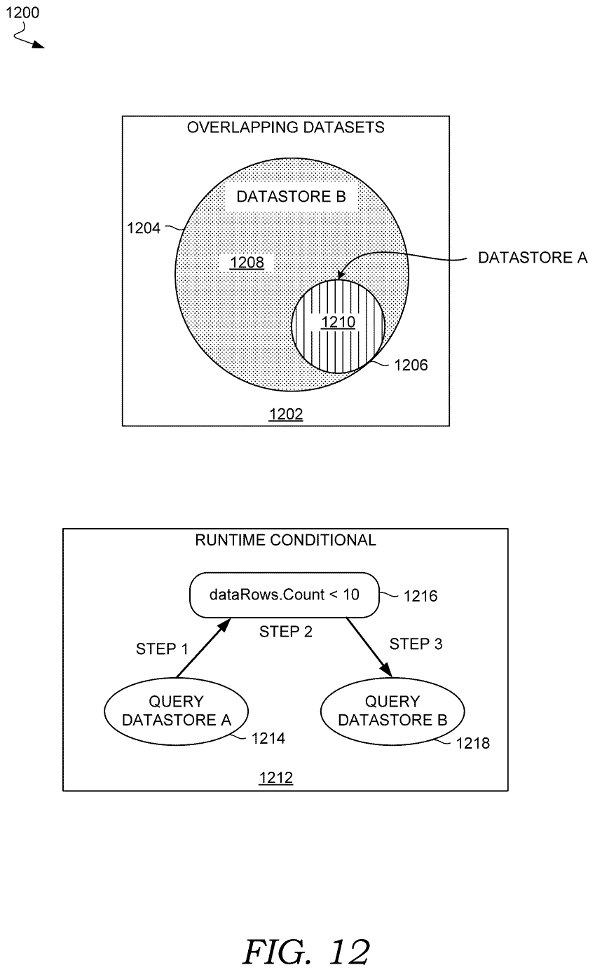

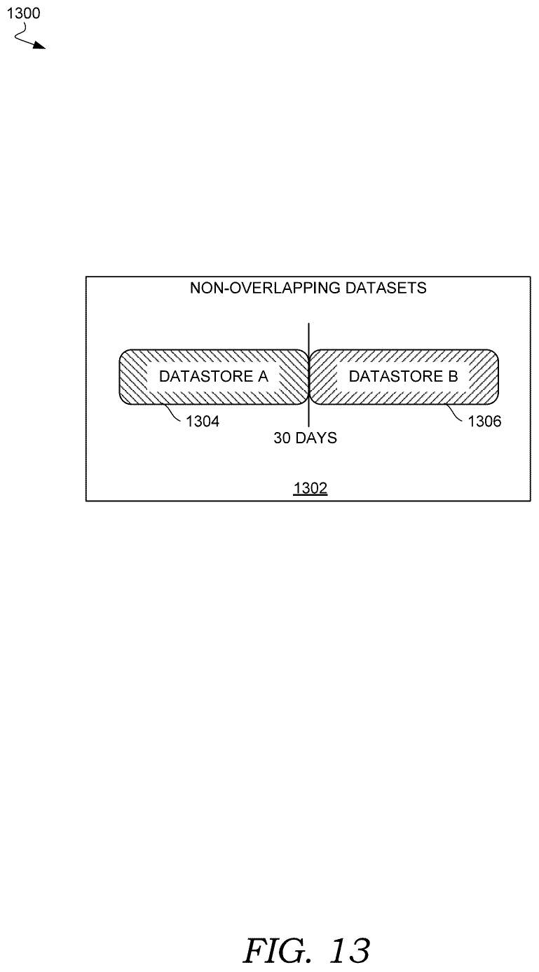

A further refinement of the described methods to calculate completeness expands path completeness, described above, to be based on these capabilities. As described above, it was difficult to correctly handle the INHERIT completeness label when differentiating different query patterns within a datastore. Using the approach of annotating a completeness measure to a tuple of (data, capability), the conditions of completeness using the capabilities and schema annotations can be defined. Here, the first query pattern from above (Person)-[: MODIFIED]→(File) maps to the fileByEdge capability, and the second query pattern from above (File2) maps to the fileByld capability. The two different conditions (find file through relationship or ID) are surfaced as two separate capabilities in the execution plan for that datastore. Each capability can be seen as its own query pattern, and the tuple of (data, capability) has defined the completeness for that query pattern. Thus, it is possible to determine which query pattern a data type belongs to. This approach, calculating predicate completeness, is described in detail below in connection with FIGS. 12 and 13.

As described herein, queries can be made more complicated by the fact that different datastores can ingest or store the same content, depending on different preconditions. For example, a data storage system can have multiple different datastores that can provide a user with files that contain the same entity types (files), but which can differ in how complete the corpus of those entities are, within each datastore.

Thus, a distributed graph query system such as that described herein should define, calculate and use the completeness of a query execution plan across multiple datastores. As described herein, some of the underlying datastores are complete in that they can guarantee that the data sought by a query exists there. Other underlying datastores that are complete, are more cache-like in that they only temporarily store the data or they only store a portion of the data. There are a number of factors that could be used to determine whether data is present in a datastore, including, but not limited to, caches with least-frequently used (LFU), most-frequently used (MFU), least-recently used (LRU), most-recently used (MRU), first-in, first-out (FIFO), last-in, first-out (LIFO), or other such policies, datastores containing only data centered around some principal or policy (such as a particular user, site, or group), datastores that ingest data based on some predicate (for example, datastores that only ingest files that the user has a relationship to, or from sites that have a boost rating, or from entities updated within some prescribed amount of time), a policy of action- or event-based data ingestion into a datastore, or other such factors.

Typically, these different systems are optimized for specific workloads where there are differences in latency, completeness, and freshness in the different stores. The federated graph query system 404 provides a mechanism to define, detect, and enforce completeness using the completeness component 416, described below. This mechanism resolves potential issues where the same query returns results of varying completeness depending on which of the heterogeneous datastores were utilized when executing the query. This reduces inconsistency for callers because they can know whether returned data is guaranteed to be complete or not. Knowing that data is guaranteed complete is key since it is difficult to otherwise know whether the data is complete or incomplete. This is because data can seem to be complete, even when it is not. As described herein, a query planner 412 uses completeness criteria from the completeness component 416 to decide between optimizing for latency, or for cost (such as computational resource usage), or for completeness, depending on the needs of a caller.

In FIG. 4, an example implementation of the federated graph query system 404 is described. This example and, in particular, the distributed graph query engine 406 that the federated graph query system 404 includes should be viewed as one potential example of how a federated graph query system 404 could be implemented and other services or programs that federate queries and fetch data from multiple different sub-systems can be considered as being within the scope of the present disclosure.

In the example illustrated in FIG. 4, the federated graph query system 404 receives a query 402 as input, which is parsed by the graph API 408 to generate an intermediate abstract syntax tree 410. The abstract syntax tree 410 is a representation of the query pattern specified by the query 402, and it indicates what data is responsive for addressing the query. This abstract syntax tree 410 is one of the inputs to the query planner 412. The query planner 412 produces a query execution plan (not shown in FIG. 4) that is executed by the federation runtime 414. The query planner 412 (also referred to herein as a query compiler) is a component of the federated graph query system 404 that takes the abstract syntax tree 410 as input and uses that to compile a query execution plan. The query planner 412 uses the collection of datastore configurations, described below, to determine which datastores to use and in what order. The query planner 412 generates commands representing these determinations, intertwined with other operations (arithmetic operations, row operations, join operations, or other operations) to generate the query execution plan. The compiled query execution plan can be executed in the runtime of the distributed graph query engine 406, as described above in connection with FIG. 3.

Query planner 412 generates a plurality of possible query execution plans and chooses the most effective one through cost-based sorting (implemented using, for example, a query planning priority queue). As described herein, completeness criteria provided by the completeness component 416 is an additional input to the query planner 412 and, in some implementations, the query planner 412 can use the completeness criteria as a cost that the priority queue sorts on, to enable the query planner 412 to choose the most complete plan. As described in connection with FIG. 3, other criteria can also be used instead of or in addition to the completeness criteria of the cost that that the priority queue sorts on, to enable the query planner 412 to choose the best plan according to the criteria used.

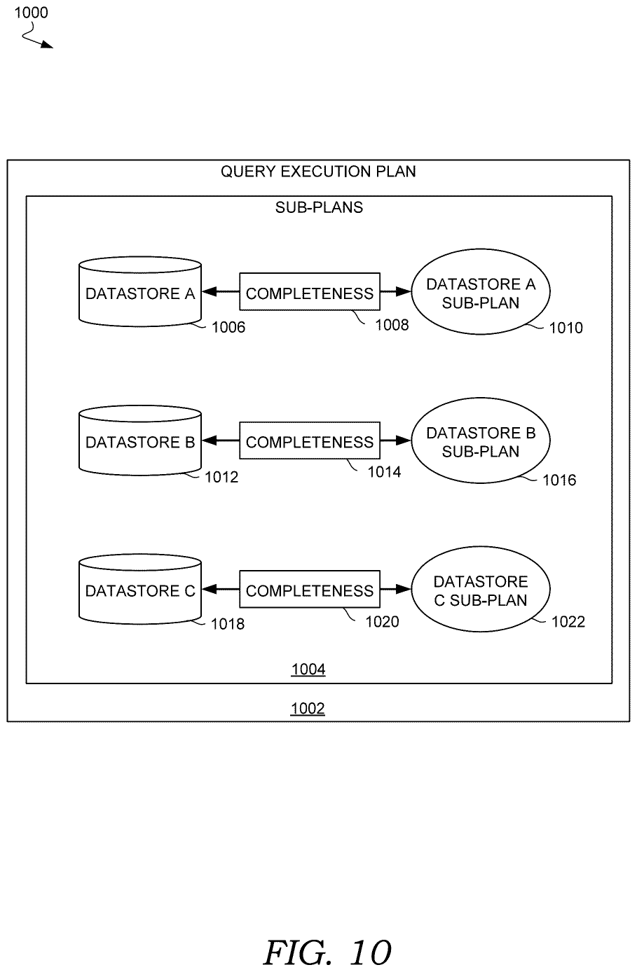

Although not shown in FIG. 4, a query execution plan describes operations made upon the federated graph to satisfy the intent of a query. In some implementations, a query execution plan is comprised of one or more sub-plans, where each sub-plan pertains to a single data source or single datastore such as datastore 424A-F. For example, the query plan for a federated graph query execution could contain one sub-plan targeting datastore 424A, one sub-plan targeting datastore 424B, one sub-plan targeting datastore 424C, and so on. A simplified view of a query execution plan is shown in FIG. 10.

In one implementation, the query planner 412 uses a query planning priority queue, which contains possible execution plans that can satisfy the query 402. The query planning priority queue can be implemented as a cost-based priority queue, where query execution plans are entered into the queue in an order determined by cost (for example, cost in computational resource usage, latency, completeness, or similar indication of constraint) where lower cost execution plans are entered into the queue before higher cost execution plans, thereby sorting the execution plans by cost. Other methods of sorting execution plans so that the most desirable plan is selected first can be considered as within the scope of the present disclosure. The priority defined for the priority queue, and thus the sort order of the plans stored in the priority queue, is calculated based on ordered sequence of cost functions. When calculating the priority of a plan, each cost function is compared separately in lexicographical order. For example, consider a plan A with four costs [1, 1, 0, 2] and a plan B with four costs [1, 0, 0, 5] that are stored in the priority queue. The four costs are ordered from the most important to the least important. To calculate the relative ordering of the two plans, the result of each cost function for the two plans would be pairwise compared, starting with the first (and most important) cost function and progressing through the sequence of cost functions in a stepwise manner (first, second, third, and fourth). In the above example, plan A would be determined to be more costly than plan B, because the second cost of plan A (1) is larger than the second cost of plan B (0). It should be noted that it typically does not matter whether the sum of the costs for plan B is greater than the sum for the cost for plan A. In one implementation, a cost function that calculates the completeness of a particular execution plan (as determined by completeness criteria) can be implemented in the first position, thereby making completeness having the highest priority of all costs. In such an implementation, plans that have equal completeness would then be sorted based on the second cost. In some implementations, the query planner can require absolute completeness so that any plan that is not calculated to be COMPLETE (as described herein) is removed from the priority queue. As may be contemplated, moving the completeness cost to the second position in favor of, for example, latency, would cause the priority queue to favor a different query execution plan.

The example illustrated in FIG. 4 shows several datastores (datastore 424A-F) that can be distributed geographically and that can be hosted using possibly incompatible service infrastructures. Additionally, these datastores may be purpose-built to serve a narrow feature set, and query capabilities are therefore tied to the specific datastore indexing and/or retrieval capabilities. In FIG. 4, the adapters or plug-ins (adapter/plug-in 418A-F) are used to provide the various capabilities of a datastore and, in some implementations, a proxy (proxy 410A-B) can be used to provide an additional layer of interface between the federation runtime 414 and the adapters or plug-ins (for example, proxy 420A for adapter/plug-in 418C or proxy 420B for adapter/plug-in 418F).

As described above, a query 402 is received by a distributed graph query engine 406 of a federated graph query system 404. The query is received by a graph API 408, which is a graph API such as graph API 306. The graph API 406 generates an abstract syntax tree 410. The abstract syntax tree 401 is used by a query planner 412 to send a query plan to a federation runtime 414, which executes the query plan. As described herein, a completeness component 416 provides completeness criteria to one or more components of the distributed graph query engine 406 such as, for example, the graph API 408, the query planner 412, and/or the federation runtime 414. Although not shown in FIG. 4, the completeness component 416 gathers the completeness criteria from the datastores (for example, datastore 424A to datastore 424F) as described herein. Also not shown in FIG. 4 are the schema 310 and the scheduler 308, which are components of query planner 412.

The federation runtime 414 receives the query plan from the query planner 412 and uses the query plan, which can comprise one or more query sub-plans, to distribute sub-queries to one or more runtime adapters or plug-ins such as adapter/plug-in 418A, adapter/plug-in 418B, adapter/plug-in 418D, and/or adapter/plug-in 418E, each of which is an adapter or plug-in for one or more datastores, as described above in connection with FIG. 3. For example, as illustrated in FIG. 4, adapter/plug-in 418A is an adapter or plug-in for datastore 424A of substrate 422, adapter/plug-in 418B is an adapter or plug-in for datastore 424B of substrate 422, adapter/plug-in 418D is an adapter or plug-in for datastore 424D of object store 426, and adapter/plug-in 418E is an adapter or plug-in for datastore 424E of object store 426. Similarly, federation runtime 414 can distribute sub-queries to one or more proxies so that, as illustrated in FIG. 4, proxy 420A is a proxy for adapter/plug-in 418C, which is an adapter or plug-in for datastore 424C and proxy 420B is a proxy for adapter/plug-in 418F, which is an adapter or plug-in for datastore 424F. Additional details about connections between the federation runtime and the datastores are described above in connection with FIG. 3.

A datastore, such as datastore 424A-F, is not necessarily a physical datastore but instead may refer to an API, database, index, service, cache or other possible source for fetching data from one or more data sources. Each datastore can have a store-specific configuration, described below, defining what is available in that datastore.

Substrate 422 comprises an infrastructure that includes various storage platforms. Similarly, object store 426 comprises another, possibly different infrastructure that includes various storage platforms. As an example, substrate 422 can be a combined infrastructure as a service/software as a service (IaaS/SaaS) provider while object store 426 can be a SaaS provider. As may be contemplated, while object store 426 is shown as an element of substrate 422 in FIG. 4, object store 426 can also be separate from or partially separate from substrate 422.

With reference now to FIGS. 5-8, example diagrams of example query plans that are determined by programmatically distributing graph queries of a graph metaphor of distributed data sources are illustratively depicted, in accordance with an implementation of the present disclosure. The example diagrams of the example query plans of FIGS. 5-8 can be implemented, such as described in connection with the components of system 200 of FIG. 2, diagram 300 of FIG. 3, and/or diagram 400 of FIG. 4.

With reference now to FIG. 5, an example diagram 500 of an example query plan that is determined by programmatically distributing graph queries of a graph metaphor of distributed data sources is illustratively depicted. As can be understood from diagram 500, an example of multiple query execution steps having the same access control data dependency is shown. In the bottom row, these have been deduplicated and replaced with a single fetch operation for the data, executed in parallel with Query Execution Step 2.

In some implementations, executing the fetch operation does not necessarily mean executing it in parallel with the last preceding operation. For example, if expected latency of fetching the token is gathered either through run-time measurements, encoded in the schema, or otherwise available to the planner, this should be included when deciding where in the instruction stream to insert the token fetch operation.

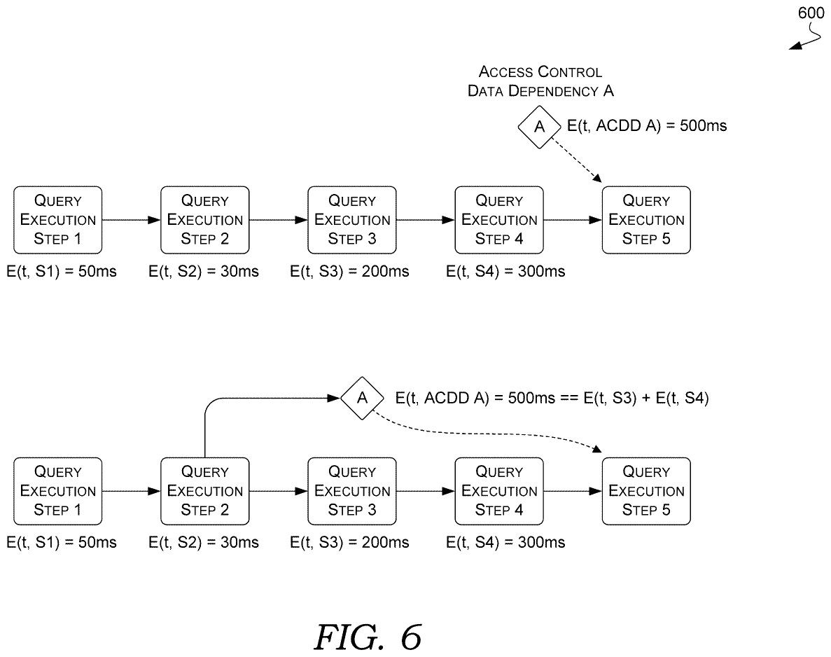

With reference now to FIG. 6, a diagram 600 of an example query plan that is determined by programmatically distributing graph queries of a graph metaphor of distributed data sources is illustratively depicted. As can be understood from diagram 600, an example of how an access control data dependency is pushed forwards in the plan based on estimated execution times of the various query execution steps is shown. The result is that the fetch operation completes just in time for its usage, rather than being executed in parallel with the last preceding step, or unnecessarily early in the query execution.

In some implementations, it might be beneficial to retain duplicate token fetch operations in the query plan. As an example, in order to satisfy a query, the execution should be split up and performed in multiple geographical regions (this could happen for compliance reasons). The execution of the per-region sub-queries can happen in parallel, and each of these has a dependency on the same access control data (token). In one example, the token is available only in the region where the query execution begins. In this case, it is likely beneficial to retrieve the token once, and pass it with each of the sub-queries bound for the individual regions where query execution should occur.

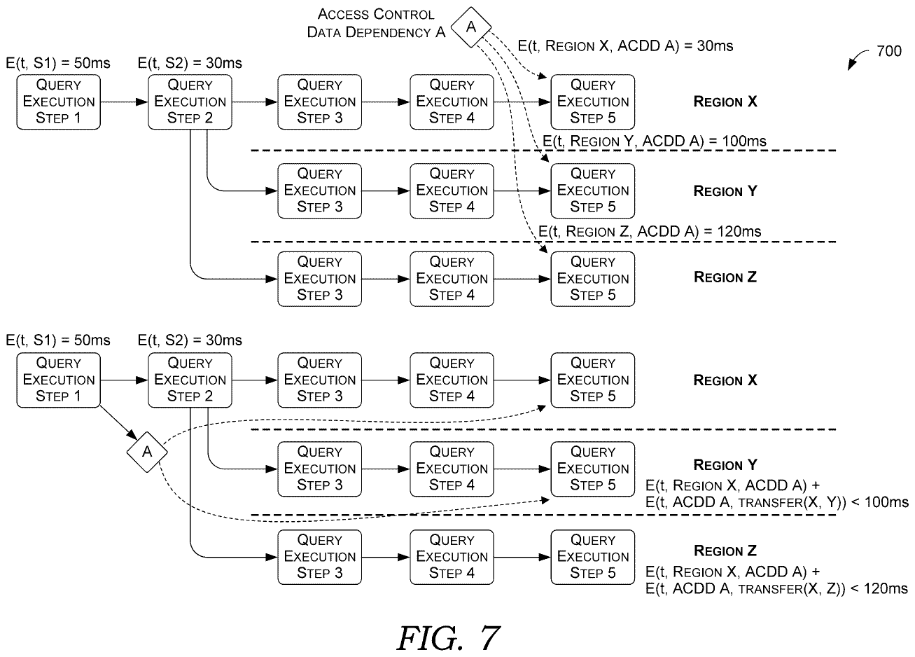

With reference now to FIG. 7, a diagram 700 of an example query plan that is determined by programmatically distributing graph queries of a graph metaphor of distributed data sources is illustratively depicted. As can be understood from diagram 700, an example of where, due to an access control data dependency only being accessible in a single region, it is beneficial to fetch this data only once and pass it along with sub-queries bound for parallel execution in specific regions.

In some implementations, the token is available through a geo-replicated service that has presence in all of the regions where the query execution should occur. In this case, it might be beneficial to include a token fetch operation in each of the region-specific sub-queries corresponding to each of the sub-plans. This might yield better performance, especially if the token payload is large, since data transfer often is a significant latency driver, especially for long distance calls such as those that span geographical regions.

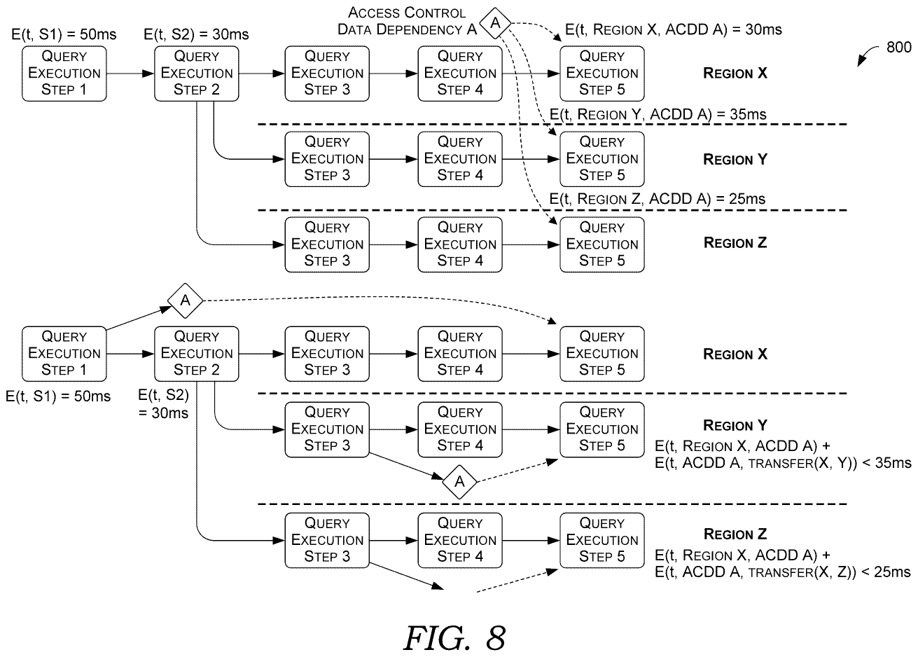

With reference now to FIG. 8, a diagram 800 of an example query plan that is determined by programmatically distributing graph queries of a graph metaphor of distributed data sources is illustratively depicted. As can be understood from diagram 800, an example of where, due to the access control data dependency being available with low latency within the individual regions, the query planner opts for including one fetch operation per region sub-query. These operations are executed in parallel or in sequence with other in-region operations.

In some implementations, hybrid cases might occur. For some regions it is beneficial to pass the token, while in others the best latency can be achieved by fetching the access control data dependency as part of the in-region sub-query. In some implementations, the query planner (for example, scheduler 308 of FIG. 3, query planner component 250 of FIG. 2, and/or query planner 412 of FIG. 4) can accommodate this by estimating the expected latency for the two options on a per-region basis and generating the execution plans accordingly. This latency can also be balanced with completeness criteria to determine the best latency so that, for example, use of a more complete datastore with higher latency can be balanced with the use of other, less complete datastores with lower latency, as described herein.

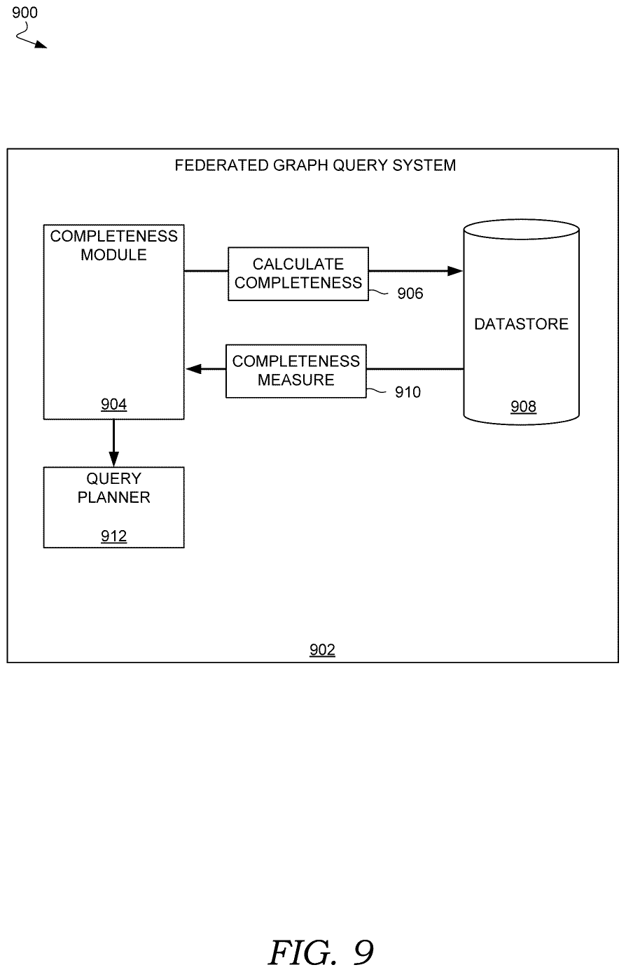

FIG. 9 is a block diagram 900 illustrating example calculations of completeness of nodes in an example federated graph query system, in accordance with an implementation of the present disclosure. In the example illustrated in FIG. 9, a completeness module 904 of a federated graph query system 902 performs operations to calculate completeness 906 of a datastore 908. Techniques to calculate completeness 906 of a datastore 908 are described in detail in connection with FIG. 4 and with FIGS. 12-13. Based on the method chosen to calculate completeness 906 of a datastore 908, a completeness measure 910 is returned which may be a completeness measure of the datastore 908, a completeness measure of data types in the datastore 908, a completeness measure of predicates associated with data in the datastore 908 based on capabilities, and/or some other such completeness measure, all as described herein in connection with FIG. 4 and FIGS. 12-13. The completeness module 904 can then provide a completeness measure (also referred to herein as completeness criteria) to other components of the federated graph query system including a query planner 912, as described herein.

FIG. 10 is a block diagram 1000 illustrating an example query execution plan for programmatically distributing graph queries of a graph metaphor of distributed data sources using completeness criteria, in accordance with an implementation of the present disclosure. In the example illustrated in FIG. 10, a query execution plan 1002 is a plan to retrieve data from datastore A 1006, datastore B 1012, and datastore C 1018. One or more sub-plans 1004 are generated for each of the datastores using completeness criteria, as described herein. In the example illustrated in FIG. 10, completeness criteria 1008 for datastore A 1006 is used to generate a datastore A sub-plan 1010, completeness criteria 1014 for datastore B 1012 is used to generate a datastore B sub-plan 1016, and completeness criteria 1020 for datastore C 1018 is used to generate a datastore C sub-plan 1022. Not shown in FIG. 10, one or more other criteria (such as latency, cost, and other criteria or metrics described herein) can also be used to generate datastore A sub-plan 1010, datastore B sub-plan 1016, and/or datastore C sub-plan 1022.

Continuing with the example of block diagram 1000 in FIG. 10, query execution plan 1002 indicates which operations are to be performed on a federated graph to satisfy the intent of a query. It is comprised of one or more subplans (for example, datastore A sub-plan 1010, datastore B sub-plan 1016, and datastore C sub-plan 1022), where each subplan pertains to a single datastore (datastore A 1006, datastore B 1012, and datastore C 1018, respectively). As illustrated in FIG. 10, the query execution plan 1002 for a federated graph query execution could contain one sub-plan targeting datastore A 1006, one sub-plan targeting datastore B 1012, and one sub-plan targeting store C 1018. The query execution plan 1002 illustrated in FIG. 10 represents a simplified query execution plan.

It should be noted that a sub-plan such as, for example, datastore A sub-plan 1010, can contain no operations on datastore A 1006 when, for example, datastore A 1006 does not contain any data that is not available in datastore B 1012 or datastore C 1018 or when datastore A has very high latency. Similarly, a query execution plan 1002 may only contain one sub-plan when, for example, a datastore such as datastore B 1012 contains all data to be performed on a federated graph to satisfy the query with reasonable cost and/or latency.

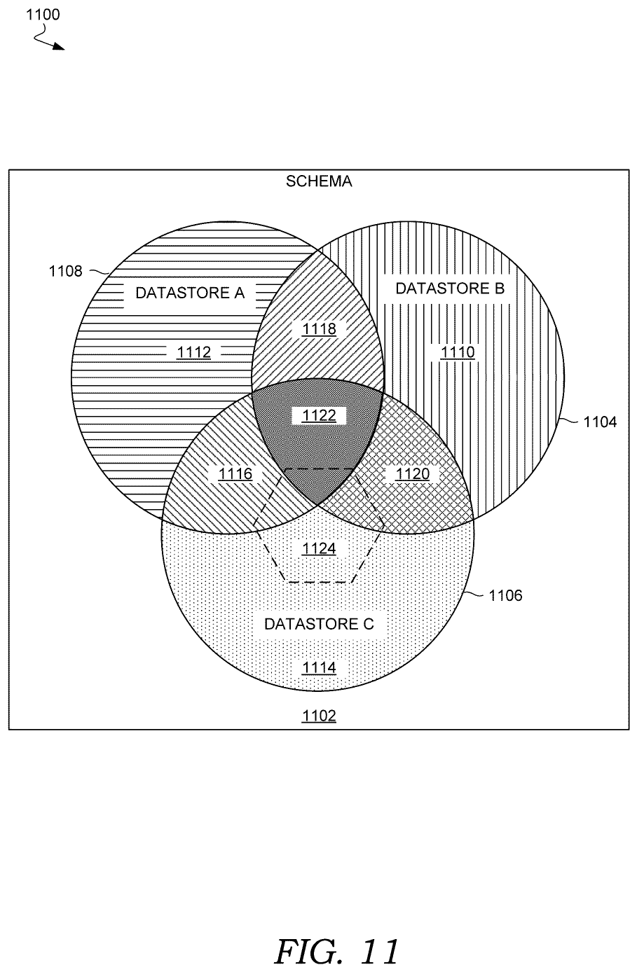

FIG. 11 is a block diagram 1100 illustrating an example schema 1102 for programmatically distributing graph queries of a graph metaphor of distributed data sources using completeness criteria, in accordance with an implementation of the present disclosure. In the example illustrated in FIG. 11, datastore A 1108 has data that is represented by areas 1112, 1116, 1118, and 1122, datastore B 1104 has data that is represented by areas 1110, 1118, 1120, and 1122, and datastore C 1106 has data that is represented by areas 1114, 1116, 1120, and 1122. Thus, area 1112 contains data that is only in datastore A 1108, area 1110 contains data that is only contained in datastore B 1104, area 1114 has data that is only contained in datastore C 1106, area 1118 has data that is contained in datastore A 1108 and datastore B 1104, but not in datastore C 1106, area 1116 has data that is contained in datastore A 1108 and datastore C 1106, but not in datastore B 1104, area 1120 has data that is contained in datastore C 1106 and datastore B 1104, but not in datastore A 1108, and area 1122 has data that is contained in datastore A 1108, datastore B 1104, and datastore C 1106.

It should be noted that these “areas” used in FIG. 11 are merely logical partitions of the data in a particular datastore and do not necessarily correspond to physical locations within a datastore. Accordingly, data in, for example, area 1122, which is contained in datastore A 1108, datastore B 1104, and datastore C 1106 is not shared data but is, instead, duplicated data. That is, the data is stored separately in datastore A 1108, datastore B 1104, and datastore C 1106. The three datastores are generally datastores in separate physical locations (in the same or different data centers), and there are three copies of the data, with one copy in datastore A 1108, one copy in datastore B 1104, and one copy in datastore C 1106.

In one implementation, the schema 1102 is a store configuration (also referred to herein as a public store configuration), which comprises a data schema for the federated data and which also includes any related metadata such as capabilities, completeness labels, and so on. The schema 1102 (or public store configuration) defines the entities (nodes) and relationships (edges) along with their properties of the federated data. Similarly, each datastore also has its own configuration or schema, referred to herein as a store specific configuration, that defines a data schema for that datastore and any related metadata for that datastore. Thus, the federated graph query systems data model is defined in a public store configuration (schema 1102), which is comprised of different store specific configurations. Because of this, there is one-to-many mapping from entities/relationships/properties in the public store configuration to entities/relationships/properties in the store specific configurations. This one-to-many mapping is caused by overlapping data in the underlying datastores as described above. Data may be referred to as overlapping if the data is identical, with the same unique identifiers, and the same formatting. As an example, data that is stored in datastore A 1108 that is identical to data that is stored in datastore B 1104 (with the same data, the same identifiers, and the same formatting) is overlapping in area 1118. However, if that data changes in datastore A 1108 but not in datastore B 1104, then that data is not identical, is not overlapping, and would be stored in area 1112 (in datastore A 1108) and in area 1110 (in datastore B 1104), but not in area 1118. Again, it is important to note that these areas are merely logical partitions that define overlapping areas of data.

Continuing the example of block diagram 1100 of FIG. 11, the capability of a datastore refers to a mechanism by which data may be fetched from the datastore. A capability of a datastore is a property associated with the datastore, which can define which data can be fetched from the datastore, how that data can be fetched from the datastore, and whether there are any restrictions on obtaining the data. A capability of a datastore can be defined in terms of a single entity, or in terms of the whole query pattern including, but not limited to, graph paths and predicates. Each entity, query pattern, and/or datastore can have multiple associated capabilities. Capabilities of datastores can involve multiple entities, relationships, and predicates over properties. Capabilities can be defined in a number of ways. For example, a capability can be defined by [QueryableBy “fileByld” “fileId” ] which indicates a configuration where an entity such as a file can be queried through the capability fileById given that the key/input fileId is given. In another example, where multiple entities/relationships are part of the same capability pattern (for example, for a graph walk that involves multiple steps), capabilities could be defined by {[QueryableBy “fileByld” “fileld” ], [QueryableBy “fileByEdgeAndPredicate” “key”], [QueryableBy “fileByEdgeAndPredicate” “key”], SchemaRelationship [[QueryableBy “fileByEdgeAndPredicate” “relationshipName”]], [QueryableBy “profileByld” “profileld” ]}. Here, there are three capabilities defined. Two simple capabilities (fileByld and profileByld) can be used to look up an entity given the appropriate ID value (fileld or profileld). The third capability, fileByEdgeAndPredicate, involves multiple entity types, with multiple relationships and properties. Using the above definition, it can be determined that the capability can, given a particular profile, follow an edge relationship (for example, MODIFIED or VIEWED) to locate a file that was either modified or viewed on or after a specified time.

Using the public store configuration (schema 1102) and the store specific configurations, a federated graph query system such as that described in connection with FIG. 4 can use the query 402, the graph API 408, and the abstract syntax tree 410 to perform query planning using query planner 412. Consider, as an example, a set of data that satisfies a query that is stored in area 1124. All of the data is in datastore C 1106, however, there is also a portion of the data in overlapping area 1116 that is also stored in datastore A 1108, a portion of the data in overlapping area 1120 that is also stored in datastore B 1104, and a portion of the data that is in overlapping area 1122 that is also stored in datastore A 1108 and in datastore B 1104.

In order to provide the data to satisfy the query, a query planner can generate a query plan to get all of the data from datastore C 1106 or get some of the data from datastore A 1108 and/or datastore B 1104. In an implementation where obtaining data from datastore A 1108 is the fastest, obtaining the data from datastore C 1106 is the slowest, and obtaining data from datastore B 1104 is faster than datastore C 1106 but slower than datastore A 1108, the query planner might get as much data as possible from datastore A 1108 (such as, for example, the data that is in overlapping area 1116 and in overlapping area 1122), some of the data from datastore B 1104 (data that is in overlapping area 1120), and the rest of the data from datastore C 1106 (in non-overlapping area 1114). Conversely, in an implementation where obtaining data from datastore A 1108 is the most expensive in terms of resource cost, obtaining the data from datastore B 1104 is the least expensive, and obtaining data from datastore C 1106 is between those two, the query planner might get as much data as possible from datastore B 1104 (such as, for example, the data that is in overlapping area 1120 and in overlapping area 1122), some or all of the rest of the data from datastore C 1106 (data that is in overlapping area 1116 and in non-overlapping area 1114), and none of the data from datastore A 1108. As may be contemplated, a federated graph query system can obtain data in parallel so that data can be simultaneously obtained from datastore A 1108, datastore B 1104, and datastore C 1106 as perscribed by the query plan.

It should be noted that, as described above, a query planner such as query planner 412 described in connection with FIG. 4 can generate a plurality of query plans based on the completeness criteria of public store configuration (schema 1102) and the store specific configurations. Using the example above, for the set of data that satisfies a query that is stored in area 1124, the data is complete for datastore C 1106 and is incomplete for datastore A 1108 and datastore B 1104. However, portions of the data in overlapping regions 1116, 1120, and 1122 are complete for datastore A 1108 and datastore B 1104.

FIG. 12 is a block diagram 1200 illustrating completeness in overlapping datasets, in accordance with an implementation of the present disclosure. In block diagram 1200, overlapping datasets 1202 include datastore A 1206 and datastore B 1204. The data in datastore A 1206 is contained in datastore B 1208 as represented by overlapping area 1210. There is also data in datastore B 1204 that is not in datastore A 1206, as represented by non-overlapping area 1208. As described above in connection with FIG. 4, predicate completeness is used when two different conditions are surfaced as two separate capabilities in the execution plan for that datastore. Each capability can be seen as its own query pattern, and the tuple of (data, capability) has defined the completeness for this query pattern.

In the example illustrated in FIG. 12, where two datastores exist, and both datastores have a set of files, datastore B 1204 has all available files, and they are deemed complete while datastore A 1206 is a cache that only contains files that have been modified within the last 30 days. Datastore B 1204 is less performant with higher expected latencies. For latency purposes, datastore A 1206 may be preferred, however datastore A 1206 may not be used for all queries for completeness reasons, unless the query expresses an intent to only fetch the most recent files (for example, [MATCH (file: File) WHERE file.fileId=“x” AND file.lastModified>datetime ( )—duration ({days: 30})]. In this instance, a capability for this pattern can be added:

```
File
{
[QueryableBy(“fileById”,“id”, CompletenessLabel =
  CompletenessLabel.INCOMPLETE)]
[QueryableBy(“fileByPredicate”,“id”, CompletenessLabel =
  CompletenessLabel.COMPLETE)]
string fileId
[QueryableBy(“fileByPredicate”, “key”, CompletenessLabel =
  CompletenessLabel.COMPLETE)]
DateTime lastModified
}
```

Here, this query pattern will match the new capability if a file lookup is performed with the lastModified predicate, which is complete. Additional predicates can be included and optionally processed by the datastore, expanding the conditions under which a file is complete in datastore A 1206 to include files modified in the last 30 days or files of importance rating over 5. A new definition to include this extra predicate would look like this:

```
File
{
[QueryableBy(″“fileById”,“id”, CompletenessLabel =
  CompletenessLabel.INCOMPLETE)]
[QueryableBy(“fileByPredicate”,“id”, CompletenessLabel =
    CompletenessLabel.COMPLETE)]
string fileId
[QueryableBy(“fileByPredicate”, “key”, CompletenessLabel =
    CompletenessLabel.COMPLETE)]
DateTime lastModified
[QueryableBy(“fileByPredicate”,“key”, CompletenessLabel =
    CompletenessLabel.COMPLETE)]
int importanceRating
}
```

Here, queries that only want files from the last 30 days can be fulfilled by datastore A 1206, as datastore A 1206 is complete for files newer than 30 days. Conversely, queries that want files from the last 60 days might be partially fulfilled by datastore A 1206 and partially fulfilled by datastore B 1204, using the less performant datastore B 1204 only for files that are older than 30 days. In one implementation, a query planner might develop a query plan that always goes for the most complete store, in this case, datastore B 1204, minimizing the complexity of the query plan at the expense of higher latency.

One method of deciding which datastore to query involves using runtime conditional statements in a query. Consider a query to the overlapping datasets 1202 that queries for files from the last 60 days, but only the ten most recent files. For such a query, it might be possible to get the ten most recent files from datastore A 1206, which is complete if all of the most recent files are less than 30 days old. However, there is no guarantee of completeness. One method of resolving this is to, as described above, always use the most complete store (datastore B 1204) regardless of performance cost. Another method uses runtime conditionals that are used by the federation runtime to evaluate conditionals during query execution. Using a runtime conditional 1212, the federation runtime can query datastore A 1214 for the ten most recent files (step 1). The federation runtime can then, at step 2, determine whether less than ten files were returned. If [dataRows.Count<10] 1216, then the federation runtime can, at step 3, query datastore B 1218 for the remaining files. This approach can result in a more resource efficient query execution plan, which gets as many files as possible (or more filed than would otherwise be provided) from the more performant datastore up to the specified ten and, if ten are not retrieved, gets the remaining files from the less performant datastore. Since it is known that the time range that datastore A has data ends at 30 days, the query planner can query datastore B for the remaining files with a predicate defining the time range as starting 30 days ago. Pairing this with a custom limit, for instance to fetch only the extra files that are to be used to satisfy the query, makes the query as resource efficient as possible.

Another method to optimize is to optimize for latency. A parallel fanout method can use more resources, but can be quicker. The parallel fanout method also solves both cases above (querying for files from the last 60 days and querying for the ten most recent files from the last 60 days). In the first case, it is not necessary to wait for datastore A to complete the request for the files that are less than 30 days old since it is already known that datastore B are queried for files in the 30-60 day range. Instead, a query execution plan is generated that sends requests to datastore A and datastore B in parallel. The predicate to datastore A will be “Modified in the last 30 days” and the predicate to datastore B will be “Modified at a time that is older than 30 days and newer than 60 days.” This query plan optimizes for latency since it allows both stores to start processing their individual queries as quickly as possible. For the second case, the query can be optimized further by applying early termination so that, if datastore A returns ten files prior to the completion of the query to datastore B, the request to datastore B can be terminate immediately.

FIG. 13 is a block diagram 1300 illustrating completeness in non-overlapping datasets, in accordance with an implementation of the present disclosure. The example illustrated in FIG. 13 is similar to that described in FIG. 12, but with the following changes. Datastore A 1304 is a most-recently used (MRU) cache that contains files modified in the last 30 days and is the preferred option due to latency. Datastore B 1306 contains older files that are used less often, so it only ingests files that were modified more than 30 days ago, but datastore B has the downside of higher latency. The runtime conditional and parallel fanout methods described in FIG. 12 work almost exactly the same for non-overlapping datasets such as non-overlapping dataset 1302. The only difference is that, in this instance, it is clearer which files are located where. The query can be split into calls to the respective stores with predicates on either <=30 days or >30 days. For the parallel fanout method on non-overlapping sets, the predicate should be set to ten for both queries (return ten files) and then unnecessary results can be removed from the results. So, for example, if one query returns eight files, only two files from the other query would be returned.

Although not illustrated in FIG. 13, one further modification to completeness calculations is to use freshness by predicate. Here, the freshness configuration of datastore A guarantees that newly modified files will be present instantly (or near instantly). In this example, datastore A is a write-focused system, which means that its freshness will be high, but the latency of read-requests is higher. Conversely, datastore B has poorer guaranteed freshness, so there will be eventual consistency within about a day. In this example, datastore B has lower latencies than datastore A.

Consider three queries:

```
Query 1:
  MATCH (file) WHERE file.id = “x” AND
  file.lastModified < datetime( ) -
  duration(Days:7)
Query 2:
  MATCH (file) WHERE file.id = “x” AND
  file.lastModified < datetime( ) -
  duration(Seconds:1)
Query 3:
  MATCH (file) WHERE file.id = “x” AND
  file.lastModified < datetime( )
```

Here query 1 is for files modified seven days ago or more so the faster datastore B can be used to fulfill the query. For query 2 and query 3, slower datastore A should be interrogated since the queries are requesting modifications that happened 1 second ago (query 2), or right now (query 3).

This situation can be addressed by defining capabilities to determine freshness of stores, just as with the previously discussed case where a file would not be present in a store thirty days after its last modification. The solution to this freshness problem is just the inverse of that, so capabilities of a store specific configuration can be defined as:

Capability freshFile from Data store A:
MATCH (file:File) WHERE file.fileId = “x” AND file.lastModified < datetime( ) -
duration(days:$limit)
Capability findFile from Data store B:
MATCH (file:File) WHERE file.fileId = “x” AND file.lastModified < datetime( ) -
duration({days:1}) AND file.lastModified > datetime( ) - duration({days:$limit})

The additional predicate in the findFile capability states that completeness cannot be guaranteed for files modified more recently than one day ago. The configuration would be defined as follows:

Data store A store specific configuration:
File
{
[QueryableBy(“freshFile”,“id”, CompletenessLabel = CompletenessLabel.COMPLETE)]
string fileId
[QueryableBy(“freshFile”, “key”, CompletenessLabel =
CompletenessLabel.COMPLETE)]
DateTime lastModified
}
Data store B store specific configuration:
File
{
[QueryableBy(“findFile”,“id”, CompletenessLabel = CompletenessLabel.COMPLETE)]
string fileId
[QueryableBy(“findFile”,“key”, CompletenessLabel = CompletenessLabel.COMPLETE)]
DateTime lastModified
}

FIG. 14 is a flow diagram 1400 of a method for obtaining disconnected semantically linked data using completeness criteria, in accordance with an implementation of the present disclosure. In an implementation, the disconnected data can be linked by identity (for example, using an identifier), as described herein. The method illustrated in flow diagram 1400 may be referred to herein as a process. The method illustrated in flow diagram 1400 may be referred to herein as method 1400. The flow diagram 1400 may be referred to herein as a process flow and/or as process flow 1400. The method illustrated in flow diagram 1400 may be carried out or performed to implement various example implementations described herein. For instance, the method illustrated in flow diagram 1400 may be performed to programmatically obtain disconnected semantically linked data using completeness criteria, which may be used to provide any of the improved electronic search technology or enhanced user computing experiences described herein.

Each block or step of process flow 1400 and other methods described herein comprises a computing process that may be performed using any combination of hardware, firmware, and/or software. For instance, various functions may be carried out by a processor executing instructions stored in memory, such as memory 1612 described in FIG. 16 and/or storage 225 described in FIG. 2. The methods may also be embodied as computer-usable instructions stored on computer storage media. The methods may be provided by a stand-alone application, a service or hosted service (stand-alone or in combination with another hosted service), or a plug-in to another product, to name a few. The blocks of process flow 1400 that correspond to actions (or steps) to be performed (as opposed to information to be processed or acted on) may be carried out by one or more computer applications or services, in some implementations, which may operate on one or more user devices (such as user device 102a), servers (such as server 106), and may be distributed across multiple user devices, and/or servers, or by a distributed computing platform, and/or may be implemented in the cloud, such as described in connection with FIG. 17. In some implementations, the functions performed by the blocks or steps of process flow 1400 are carried out by components of systems such as those described in connection with FIGS. 1-4.

With reference to FIG. 14, aspects of example process flow 1400 are illustratively provided for programmatically obtaining disconnected semantically linked data using completeness criteria. In particular, example process flow 1400 may be performed be elements of the example computing architecture described in connection with FIG. 2, to use a distributed graph query engine to collect disconnected semantically linked data into a single coherent graph abstraction through a schema, using completeness criteria, as described in FIG. 3, and/or to use a federated graph query system to collect disconnected semantically linked data into a single coherent graph abstraction, using completeness criteria, as described in FIG. 4.

At block 1402, the method illustrated in flow diagram 1400 includes receiving a query to obtain data from a distributed data source. In some aspects, after block 1402, the method illustrated in flow diagram 1400 continues at block 1404.

At block 1404, the method illustrated in flow diagram 1400 includes determining a completeness criteria corresponding to each data source of the distributed data source based on the query. In some aspects, the completeness criteria is based on the query received at block 1402 so that, for example, a data source is determined to be complete when the data source has complete data for the particular query. In some aspects, after block 1404, the method illustrated in flow diagram 1400 continues at block 1406.

In some implementations, as shown at block 1406, the method illustrated in flow diagram 1400 includes generating a set or list of candidate data sources based on the completeness criteria. In some aspects, the set or list of candidate data sources comprises data sources that at least partially satisfy the completeness criteria for the query received at block 1402. In some aspects, after block 1406, the method illustrated in flow diagram 1400 continues at block 1408.

At block 1408, the method illustrated in flow diagram 1400 includes generating a query plan comprising a plurality of sub-plans to satisfy the query based on the completeness criteria. In some aspects, the query plan and the plurality of sub-plans includes one sub-plan for each of the candidate data sources generated at block 1406. In some aspects, the plurality of sub-plans comprise sub-plans to query the candidate data sources of the list of candidate data sources generated at block 1406. In some aspects, after block 1408, the method illustrated in flow diagram 1400 continues at block 1410.

At block 1410, the method illustrated in flow diagram 1400 includes generating a plurality of sub-queries corresponding to the sub-plans so that, for example, for each sub-plan generated at block 1408, one or more sub-queries is generated. In some aspects, at block 1410, the method illustrated in flow diagram 1400 includes generating sub-queries, for example, to the candidate data sources generated at block 1406, corresponding to each of these sub-plans, thereby generating a plurality of sub-queries. In some aspects, after block 1420, the method illustrated in flow diagram 1400 continues at block 1412.

At block 1412, the method illustrated in flow diagram 1400 includes submitting the plurality of sub-queries to the distributed data source. In some aspects, after block 1412, the method illustrated in flow diagram 1400 continues at block 1414.

At block 1414, the method illustrated in flow diagram 1400 includes providing a response to the query based on responses to the plurality of sub-queries. In some aspects, after block 1414, the method illustrated in flow diagram 1400 terminates. In some aspects, not shown in FIG. 14, after block 1414, the method illustrated in flow diagram 1400 continues at block 1402 to receive a query to obtain data from a distributed data source.

Accordingly, various aspects of technology directed to systems and methods for intelligently processing and presenting, on a computing device, group data that is contextualized for a user, are described. It is understood that various features, sub-combinations, and modifications of the implementations described herein are of utility and may be employed in other implementations without reference to other features or sub-combinations. Moreover, the order and sequences of steps shown in the example method 1400 are not meant to limit the scope of the present disclosure in any way, and in fact, the steps may occur in a variety of different sequences within implementations hereof. Such variations and combinations thereof are also contemplated to be within the scope of implementations provided in this disclosure.

FIG. 15 is a flow diagram 1500 of a method for obtaining disconnected semantically linked data using completeness criteria, in accordance with an implementation of the present disclosure. The method illustrated in flow diagram 1500 may be referred to herein as a process. The method illustrated in flow diagram 1500 may be referred to herein as method 1500. The flow diagram 1500 may be referred to herein as a process flow and/or as process flow 1500. The method illustrated in flow diagram 1500 may be carried out or performed to implement various example implementations described herein. For instance, the method illustrated in flow diagram 1500 may be performed to programmatically obtain disconnected semantically linked data using completeness criteria, which may be used to provide any of the improved electronic search technology or enhanced user computing experiences described herein.

Each block or step of process flow 1500 and other methods described herein comprises a computing process that may be performed using any combination of hardware, firmware, and/or software. For instance, various functions may be carried out by a processor executing instructions stored in memory, such as memory 1612 described in FIG. 16 and/or storage 225 described in FIG. 2. The methods may also be embodied as computer-usable instructions stored on computer storage media. The methods may be provided by a stand-alone application, a service or hosted service (stand-alone or in combination with another hosted service), or a plug-in to another product, to name a few. The blocks of process flow 1500 that correspond to actions (or steps) to be performed (as opposed to information to be processed or acted on) may be carried out by one or more computer applications or services, in some implementations, which may operate on one or more user devices (such as user device 102a), servers (such as server 106), and may be distributed across multiple user devices, and/or servers, or by a distributed computing platform, and/or may be implemented in the cloud, such as described in connection with FIG. 17. In some implementations, the functions performed by the blocks or steps of process flow 1500 are carried out by components of systems such as those described in connection with FIGS. 1-4.

With reference to FIG. 15, aspects of example process flow 1500 are illustratively provided for programmatically obtaining disconnected semantically linked data using completeness criteria. In particular, example process flow 1500 may be performed by elements of the example computing architecture described in connection with FIG. 2, to use a distributed graph query engine to collect disconnected semantically linked data into a single coherent graph abstraction through a schema, using completeness criteria, as described in FIG. 3, and/or to use a federated graph query system to collect disconnected semantically linked data into a single coherent graph abstraction, using completeness criteria, as described in FIG. 4.

At block 1502, the method illustrated in flow diagram 1500 includes identifying data sources of a distributed data source. In some aspects, after block 1502, the method illustrated in flow diagram 1500 continues at block 1504.

At block 1504, the method illustrated in flow diagram 1500 includes receiving a query to the distributed data source. In some aspects, after block 1504, the method illustrated in flow diagram 1500 continues at block 1506.

At block 1506, the method illustrated in flow diagram 1500 includes calculating a completeness criteria for the identified data sources. In some aspects, after block 1506, the method illustrated in flow diagram 1500 continues at block 1508. Some implementations of block 1506 further include using the completeness criteria to determine a set of complete data sources.

At block 1508, some implementations of the method illustrated in flow diagram 1500 include using schema annotations to mark which data sources are complete for the query based on the criteria. In some aspects, after block 1508, the method illustrated in flow diagram 1500 continues at block 1510.

At block 1510, the method illustrated in flow diagram 1500 includes determining an execution plan for the query based on cost-based sorting. In some implementations, the execution plan is further determined based on the set of complete data sources determined in some implementations of block 1506. In some aspects, after block 1510, the method illustrated in flow diagram 1500 continues at block 1512.

At block 1512, the method illustrated in flow diagram 1500 includes retrieving data from the distributed data source based on the execution plan. In some aspects, after block 1512, the method illustrated in flow diagram 1500 continues at block 1514.

At block 1514, the method illustrated in flow diagram 1500 includes providing the retrieved data as a response to the query. In some aspects, after block 1514, the method illustrated in flow diagram 1500 terminates. In some aspects, not shown in FIG. 15, after block 1514, the method illustrated in flow diagram 1500 continues at block 1502 to identify more data sources of a distributed data source.

Accordingly, various aspects of technology directed to systems and methods for intelligently processing and presenting, on a computing device, group data that is contextualized for a user are described. It is understood that various features, subcombinations, and modifications of the implementations described herein are of utility and may be employed in other implementations without reference to other features or subcombinations. Moreover, the order and sequences of steps shown in the example method 1500 are not meant to limit the scope of the present disclosure in any way, and in fact, the steps may occur in a variety of different sequences within implementations hereof. Such variations and combinations thereof are also contemplated to be within the scope of implementations provided in this disclosure.

### Other Implementations

In some implementations, a computerized system to programmatically distribute graph queries of a graph metaphor using a knowledge graph of distributed data sources based on completeness is provided, using any of the implementations described above. The computerized system comprises at least one processor, and computer memory storing computer-readable instructions, that, when executed by the at least one processor, cause the at least one processor to perform operations. The operations comprise receiving a query to obtain data from a distributed data source. The distributed data source comprises one or a plurality of data sources. The operations further comprise determining a completeness criteria corresponding to each data source of the distributed data source. The determination is based at least in part on the query. The operations further comprise generating a query plan based at least on the completeness criteria. The query plan is generated to satisfy the query and the generated query plan comprises a plurality of sub-plans, each sub-plan corresponding to at least one data source of the distributed data source. The operations further comprise generating a sub-query corresponding to each of the sub-plans, thereby generating a plurality of sub-queries. The operations further comprise executing at least a portion of the sub-queries using the distributed data source to determine a response from the distributed data source to each of the executed sub-queries. The operations further comprise generating a response to the query based on the response to each of the executed sub-queries.

Advantageously, these and other implementations, as described herein, improve existing computing technologies by providing new or improved functionality in computing applications including automated computing technology for programmatically distributing graph queries of a graph metaphor of distributed data sources by determining a query execution plan based on completeness determined from properties stored with respect to the graph metaphor, as provided herein, can be beneficial for enabling improved computing applications and an improved user computing experience. For example, automated computing technology for programmatically distributing graph queries of a graph metaphor of distributed data sources by determining a query execution plan based on completeness speeds up the query execution and reduces the latency and/or computing and networking resources utilized during search query operations of a graph metaphor of distributed data sources by facilitating completeness-based distribution of sub-queries of the distributed data sources. The distribution of the queries to the distributed data sources based on completeness speeds up the query execution and reduces the latency and/or computing and networking resources utilized as the sub-queries can be efficiently executed across the distributed data sources (for example, as well as the corresponding database management system of each of the distributed data sources) allowing for simultaneous data retrieval operations and/or access control operations, thereby reducing the total response time to the query and reducing the overhead associated with repeating queries that return incomplete data. In this regard, the speed of the query execution is increased, latency is decreased, the efficacy of the queries is increased, and/or the computing and network resources are conserved. Further, implementations provided in this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, implementations provided in this disclosure enable an improved user experience across a number of computer devices, applications, and platforms. Further still, implementations described herein enable the programmatic distribution of graph queries of a graph metaphor of distributed data sources without requiring computer tools and resources for a user to manually perform operations to produce this outcome and/or resubmit queries. In this way, some implementations, as described herein, reduce or eliminate a need for certain data sources, data storage, and computer controls for enabling manually performed steps by an administrator, or the user themselves, to search, identify, assess, and configure specific, static data, thereby reducing the consumption of computing resources.

In any combination of the implementations provided herein, the distributed data source is a component of a distributed graph query engine.

In any combination of the implementations provided herein, the distributed data source is a component of a federated graph query system.

In any combination of the implementations provided herein, the completeness criteria is calculated using predicate completeness that determines a query pattern of each data type of the datastore.

In any combination of the implementations provided herein, the data sources of the distributed data source include one or more heterogeneous data sources.

In any combination of the implementations provided herein, the operations further comprise generating a set of candidate data sources. The set of candidate data sources comprises at least one data source and is generated based on the completeness criteria and from the plurality of data sources of the distributed data sources. Each candidate data source of the set at least partially satisfies the completeness criteria for the query. Each sub-plan of the plurality of sub-plans is configured to query a candidate data source of the set of candidate data sources.

In any combination of the implementations provided herein, generating the query plan comprising a plurality of sub-plans to satisfy the query based on the completeness criteria comprises generating a plurality of query plans that satisfy the query. Generating the query plan comprising a plurality of sub-plans to satisfy the query based on the completeness criteria may further comprise sorting the plurality of query plans using a query planning priority queue. Generating the query plan comprising a plurality of sub-plans to satisfy the query based on the completeness criteria may further comprise selecting the lowest-cost query plan from the query planning priority queue as the query plan.

In any combination of the implementations provided herein, the operations further comprise using schema annotations to mark which data sources are complete for the query based, at least in part, on the completeness criteria.

In any combination of the implementations provided herein, providing the response to the query based on responses to the plurality of sub-queries comprises culling responses from one or more of the responses to the plurality of sub-queries to remove duplicate data.

In some implementations, a computer-implemented method to programmatically distribute graph queries of a graph metaphor using a knowledge graph of distributed data sources based on completeness is provided, using any of the implementations described above. The method comprises identifying data sources of a distributed data source. The method may further comprise receiving a query to obtain data from the distributed data source. The method may further comprise calculating a completeness criteria for the identified data sources. The method may further comprise using schema annotations to mark which data sources are complete for the query based, at least in part, on the completeness criteria. The method may further comprise determining a query execution plan for the query based, at least in part, on cost-based sorting. The method may further comprise retrieving data from the distributed data source based on the query execution plan. The method may further comprise providing the retrieved data as a response to the query.

Advantageously, these and other implementations, as described herein, improve existing computing technologies by providing new or improved functionality in computing applications including automated computing technology for programmatically distributing graph queries of a graph metaphor of distributed data sources by determining a query execution plan based on completeness determined from properties stored with respect to the graph metaphor, as provided herein, can be beneficial for enabling improved computing applications and an improved user computing experience. For example, automated computing technology for programmatically distributing graph queries of a graph metaphor of distributed data sources by determining a query execution plan based on completeness speeds up the query execution and reduces the latency and/or computing and networking resources utilized during search query operations of a graph metaphor of distributed data sources by facilitating completeness-based distribution of sub-queries of the distributed data sources. The distribution of the queries to the distributed data sources based on completeness speeds up the query execution and reduces the latency and/or computing and networking resources utilized as the sub-queries can be efficiently executed across the distributed data sources (for example, as well as the corresponding database management system of each of the distributed data sources) allowing for simultaneous data retrieval operations and/or access control operations, thereby reducing the total response time to the query and reducing the overhead associated with repeating queries that return incomplete data. In this regard, the speed of the query execution is increased, latency is decreased, the efficacy of the queries is increased, and/or the computing and network resources are conserved. Further, implementations provided in this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, implementations provided in this disclosure enable an improved user experience across a number of computer devices, applications, and platforms. Further still, implementations described herein enable the programmatic distribution of graph queries of a graph metaphor of distributed data sources without requiring computer tools and resources for a user to manually perform operations to produce this outcome and/or resubmit queries. In this way, some implementations, as described herein, reduce or eliminate a need for certain data sources, data storage, and computer controls for enabling manually performed steps by an administrator, or the user themselves, to search, identify, assess, and configure specific, static data, thereby reducing the consumption of computing resources.

In any combination of the implementations provided herein, the query execution plan comprises a plurality of sub-plans usable to satisfy the query, based on the completeness criteria.

In any combination of the implementations provided herein, the query execution plan comprises a plurality of sub-plans usable to satisfy the query, based on latency criteria.

In any combination of the implementations provided herein, the completeness criteria is a completeness measure of data managed by the corresponding data source.

In any combination of the implementations provided herein, the query execution plan comprises a plurality of sub-plans, each corresponding to a single data source of the distributed data source.

In some implementations, one or more computer storage media having computer-executable instructions embodied thereon that, when executed by a computing system having at least one processor and at least one memory, cause the at least one processor to perform operations to programmatically distribute graph queries of a graph metaphor using a knowledge graph of distributed data sources based on completeness is provided, using any of the implementations described above. The operations comprise receiving a query to obtain data from the distributed data source that comprises a plurality of data stores. The operations further comprise determining a completeness criteria corresponding to each data store of the distributed data source based on the query. The operations further comprise generating a plurality of query execution plans that satisfy the query, each query execution plan comprising a plurality of sub-plans. The operations further comprise selecting a query execution plan of the plurality of query execution plans, for example, a query execution plan is selected programmatically based on a determination of latency or cost (such as cost in terms of computational resource usage) of a query execution plan. In some implementations, the query execution plan that is selected is determined to have the lowest cost, lowest latency, or a balance of lowest cost and lowest latency. The operations further comprise generating a plurality of sub-queries, each sub-query corresponding to a sub-plan of the selected query execution plan. The operations further comprise executing, on the distributed data source, at least a portion of sub-queries of the selected query execution plan, to determine a response to each of the executed sub-queries. The operations further comprise generating a response to the query based on the response to at last one of the executed sub-queries. The operations further comprise causing the response to the query to be provided. For example the response may be provided to a user who has submitted to the query or in response to another computer system service that has caused the query to be performed.

Advantageously, these and other implementations, as described herein, improve existing computing technologies by providing new or improved functionality in computing applications including automated computing technology for programmatically distributing graph queries of a graph metaphor of distributed data sources by determining a query execution plan based on completeness determined from properties stored with respect to the graph metaphor, as provided herein, can be beneficial for enabling improved computing applications and an improved user computing experience. For example, automated computing technology for programmatically distributing graph queries of a graph metaphor of distributed data sources by determining a query execution plan based on completeness speeds up the query execution and reduces the latency and/or computing and networking resources utilized during search query operations of a graph metaphor of distributed data sources by facilitating completeness-based distribution of sub-queries of the distributed data sources. The distribution of the queries to the distributed data sources based on completeness speeds up the query execution and reduces the latency and/or computing and networking resources utilized as the sub-queries can be efficiently executed across the distributed data sources (for example, as well as the corresponding database management system of each of the distributed data sources) allowing for simultaneous data retrieval operations and/or access control operations, thereby reducing the total response time to the query and reducing the overhead associated with repeating queries that return incomplete data. In this regard, the speed of the query execution is increased, latency is decreased, the efficacy of the queries is increased, and/or the computing and network resources are conserved. Further, implementations provided in this disclosure address a need that arises from a very large scale of operations created by software-based services that cannot be managed by humans. The actions/operations described herein are not a mere use of a computer, but address results of a system that is a direct consequence of software used as a service offered in conjunction with user communication through services hosted across a variety of platforms and devices. Further still, implementations provided in this disclosure enable an improved user experience across a number of computer devices, applications, and platforms. Further still, implementations described herein enable the programmatic distribution of graph queries of a graph metaphor of distributed data sources without requiring computer tools and resources for a user to manually perform operations to produce this outcome and/or resubmit queries. In this way, some implementations, as described herein, reduce or eliminate a need for certain data sources, data storage, and computer controls for enabling manually performed steps by an administrator, or the user themselves, to search, identify, assess, and configure specific, static data, thereby reducing the consumption of computing resources.

In any combination of the implementations provided herein, the completeness criteria is calculated using data type completeness.

In any combination of the implementations provided herein, the completeness criteria is calculated using predicate completeness.

In any combination of the implementations provided herein, the completeness criteria is calculated using store completeness.

In any combination of the implementations provided herein, the completeness criteria is calculated using path completeness.

In any combination of the implementations provided herein, the data sources of the distributed data source include one or more homogeneous data sources.

In any combination of the implementations provided herein, the data sources of the distributed data source include one or more overlapping data sources.

In any combination of the implementations provided herein, the data sources of the distributed data source include one or more partially overlapping data sources.

In any combination of the implementations provided herein, the data sources of the distributed data source include one or more non-overlapping data sources.

### Example Computing Environments

Having described various implementations, several example computing environments suitable for implementing implementations of the disclosure are now described, including an example computing device and an example distributed computing environment in FIGS. 16 and 17, respectively. With reference to FIG. 16, an exemplary computing device is provided and referred to generally as computing device 1600. The computing device 1600 is but one example of a suitable computing environment and is not intended to suggest any limitation as to the scope of use or functionality of implementations of the disclosure. Neither should the computing device 1600 be interpreted as having any dependency or requirement relating to any one or combination of components illustrated.

Implementations of the disclosure may be described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Implementations of the disclosure may be practiced in a variety of system configurations, including mobile devices, consumer electronics, general-purpose computers, more specialty computing devices, or the like. Implementations of the disclosure may also be practiced in distributed computing environments where tasks are performed by remote-processing devices that are linked through a communications network. In a distributed computing environment, program modules may be located in both local and remote computer storage media including memory storage devices.

Some implementations may comprise an end-to-end software-based system that can operate within system components described herein to operate computer hardware to provide system functionality. At a low level, hardware processors may execute instructions selected from a machine language (also referred to as machine code or native) instruction set for a given processor. The processor recognizes the native instructions and performs corresponding low level functions relating to, for example, logic, control, and memory operations. Low level software written in machine code can provide more complex functionality to higher levels of software. Accordingly, in some implementations, computer-executable instructions may include any software, including low level software written in machine code, higher level software such as application software, and any combination thereof. In this regard, the system components can manage resources and provide services for system functionality. Any other variations and combinations thereof are contemplated with the implementations of the present disclosure.

With reference to FIG. 16, computing device 1600 includes a bus 1610 that directly or indirectly couples the following devices: memory 1612, one or more processors 1614, one or more presentation components 1616, one or more input/output (I/O) ports 1618, one or more I/O components 1620, and an illustrative power supply 1622. Bus 1610 represents what may be one or more buses (such as an address bus, data bus, or combination thereof). Although the various blocks of FIG. 16 are shown with lines for the sake of clarity, in reality, these blocks represent logical, not necessarily actual, components. For example, one may consider a presentation component such as a display device to be an I/O component. In another example, one may consider that processors have memory. The inventors hereof recognize that such is the nature of the art and reiterate that the diagram of FIG. 16 is merely illustrative of an exemplary computing device that can be used in connection with one or more implementations of the present disclosure. Distinction is not made between such categories as “workstation,” “server,” “laptop,” or “handheld device,” as all are contemplated within the scope of FIG. 16 and with reference to “computing device.”

Computing device 1600 typically includes a variety of computer-readable media. Computer-readable media can be any available media that can be accessed by computing device 1600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1612 includes computer storage media in the form of volatile and/or nonvolatile memory. The memory may be removable, non-removable, or a combination thereof. Exemplary hardware devices include, for example, solid-state memory, hard drives, and optical-disc drives. Computing device 1600 includes one or more processors 1614 that read data from various entities such as memory 1612 or I/O components 1620. Presentation component(s) 1616 presents data indications to a user or other device. Exemplary presentation components include a display device, speaker, printing component, vibrating component, and the like.

The I/O ports 1618 allow computing device 1600 to be logically coupled to other devices, including I/O components 1620, some of which may be built in. Illustrative components include a microphone, joystick, game pad, satellite dish, scanner, printer, or a wireless device. The I/O components 1620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1600. The computing device 1600 may be equipped with depth cameras, such as stereoscopic camera systems, infrared camera systems, RGB camera systems, and combinations of these, for gesture detection and recognition. Additionally, the computing device 1600 may be equipped with accelerometers or gyroscopes that enable detection of motion. The output of the accelerometers or gyroscopes may be provided to the display of the computing device 1600 to render immersive augmented reality or virtual reality.

Some implementations of computing device 1600 may include one or more radio(s) (or similar wireless communication components). The radio transmits and receives radio or wireless communications. The computing device 1600 may be a wireless terminal adapted to receive communications and media over various wireless networks. Computing device 1600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When “short” and “long” types of connections are referred to, it is not meant to refer to the spatial relation between two devices. Instead, these generally refer to short range and long range as different categories, or types, of connections (for example, a primary connection and a secondary connection). A short-range connection may include, by way of example and not limitation, a Wi-Fi® connection to a device (for example, a mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Referring now to FIG. 17, an example distributed computing environment 1700 is illustratively provided, in which implementations of the present disclosure may be employed. In particular, FIG. 17 shows a high level architecture of an example cloud computing platform 1710 that can host a technical solution environment, or a portion thereof (for example, a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 1700 that includes cloud computing platform 1710, rack 1720, and node 1730 (for example, computing devices, processing units, or blades) in rack 1720. The technical solution environment can be implemented with cloud computing platform 1710, which runs cloud services across different data centers and geographic regions. Cloud computing platform 1710 can implement fabric controller 1740 component for provisioning and managing resource allocation, deployment, upgrade, and management of cloud services. Typically, cloud computing platform 1710 acts to store data or run service applications in a distributed manner. Cloud computing infrastructure 1710 in a data center can be configured to host and support operation of endpoints of a particular service application. Cloud computing infrastructure 1710 may be a public cloud, a private cloud, or a dedicated cloud.

Node 1730 can be provisioned with host 1750 (for example, operating system or runtime environment) running a defined software stack on node 1730. Node 1730 can also be configured to perform specialized functionality (for example, compute nodes or storage nodes) within cloud computing platform 1710. Node 1730 is allocated to run one or more portions of a service application of a tenant. A tenant can refer to a customer utilizing resources of cloud computing platform 1710. Service application components of cloud computing platform 1710 that support a particular tenant can be referred to as a multi-tenant infrastructure or tenancy. The terms “service application,” “application,” or “service” are used interchangeably with regards to FIG. 17, and broadly refer to any software, or portions of software, that run on top of, or access storage and computing device locations within, a datacenter.

When more than one separate service application is being supported by nodes 1730, nodes 1730 may be partitioned into virtual machines (for example, virtual machine 1752 and virtual machine 1754). Physical machines can also concurrently run separate service applications. The virtual machines or physical machines can be configured as individualized computing environments that are supported by resources 1760 (for example, hardware resources and software resources) in cloud computing platform 1710. It is contemplated that resources can be configured for specific service applications. Further, each service application may be divided into functional portions such that each functional portion is able to run on a separate virtual machine. In cloud computing platform 1710, multiple servers may be used to run service applications and perform data storage operations in a cluster. In particular, the servers may perform data operations independently but exposed as a single device, referred to as a cluster. Each server in the cluster can be implemented as a node.

Client device 1780 may be linked to a service application in cloud computing platform 1710. Client device 1780 may be any type of computing device, such as user device 102n described with reference to FIG. 1, and the client device 1780 can be configured to issue commands to cloud computing platform 1710. In implementations, client device 1780 may communicate with service applications through a virtual Internet Protocol (IP) and load balancer or other means that direct communication requests to designated endpoints in cloud computing platform 1710. The components of cloud computing platform 1710 may communicate with each other over a network (not shown), which may include, without limitation, one or more local area networks (LANs) and/or wide area networks (WANs). Additional Structural and Functional Features of Implementations of the Technical Solution

Having identified various components utilized herein, it should be understood that any number of components and arrangements may be employed to achieve the desired functionality within the scope of the present disclosure. For example, the components in the implementations depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Implementations described in the paragraphs below may be combined with one or more of the specifically described alternatives. In particular, an implementation that is claimed may contain a reference, in the alternative, to more than one other implementation. The implementation that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, implementations of the present disclosure are described with reference to a computing device or a distributed computing environment; however the computing device and distributed computing environment depicted herein is merely exemplary. Components can be configured for performing novel aspects of implementations, where the term “configured for” can refer to “programmed to” perform particular tasks or implement particular abstract data types using code. Further, while implementations of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Implementations of the present disclosure have been described with the intent to be illustrative rather than restrictive. Alternative implementations will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A system comprising:
at least one processor; and
computer memory storing programming instructions for execution by the processor, the programming instructions, upon execution by the processor, causing the system to perform the following operations:
receiving a query for a distributed graph database system that includes multiple distributed data sources, wherein data stored by a first one of the distributed data sources overlaps with data stored by a second one of the distributed data sources;
determining completeness criteria corresponding to the first data source and the second data source after receiving the query;
generating a query execution plan based at least on the completeness criteria corresponding to the first data source and the second data source, the query execution plan indicating an order for querying the distributed data sources during execution of the query by the distributed graph database system;
executing, by the distributed graph database system, at least a portion of the query based on the query execution plan to obtain a response to the query; and
outputting the response to the query following execution of the query.

2.-6. (canceled)

7. The system of claim 1, wherein generating the query plan comprising a plurality of sub-plans to satisfy the query based on the completeness criteria comprises:
generating a plurality of query plans that satisfy the query; and
selecting, as the query plan from plurality of query plans, a particular query plan, the selecting based on latency or cost in regards to computational resource usage.

8.-20. (canceled)

21. The system of claim 1, wherein the first distributed data source and the second distributed data source are components of a federated graph query system.

22. The system of claim 1, wherein the completeness criteria is determined based on a query pattern of each data type of a datastore of the distributed data source.

23. The system of claim 1, wherein the multiple distributed data sources include at least one heterogeneous data source.

24. The system of claim 1, wherein the query execution plan includes sub-plans, and wherein each of the sub-plans is configured to query a specific one of the distributed data sources.

25. The system of claim 24, wherein generating the query execution plan includes:
identifying, from the distributed data source, a set of candidate data sources for responding to the query based on the completeness criteria, wherein at least one of the candidate data sources satisfies fewer than all of the completeness criteria for the query; and
generating query sub-plans for querying the candidate data sources using the completeness criteria, the query sub-plans being included in the query execution plan.

26. The system of claim 25, wherein executing at least a portion of the query based on the query execution plan includes:
sending sub-queries to the candidate data sources based on the query sub-plans;
receiving responses to the sub-queries from the candidate data sources; and
combining the responses to the sub-queries to obtain the response to the query.

27. The system of claim 1, wherein the completeness criteria includes binary completeness that classifies a data source or data item as either complete or incomplete.

28. The system of claim 1, wherein the completeness criteria includes gradient completeness that assigns a completeness value within a range to indicate a degree of completeness of a data source or data item.

29. The system of claim 1, wherein the completeness criteria includes store-based completeness that assigns a completeness measure to an entire datastore such that data types within the datastore are treated as having a same completeness.

30. The system of claim 1, wherein the completeness criteria includes type-based completeness that assigns respective completeness measures to different data types within a datastore.

31. The system of claim 1, wherein the completeness criteria includes path completeness that determines completeness of a data type based on a query path by which the data type is reached.

32. The system of claim 31, wherein the path completeness treats a completeness label associated with a data type as inherited from a preceding entity or relationship in the query path.

33. The system of claim 1, wherein the programming instructions further cause the system to perform the following operations:
marking at least two of the distributed data sources as partially complete based on the completeness criteria; and
combining, based on one or more schema annotations, the at least two distributed data sources into a single complete data source, wherein the one or more schema annotations indicate completeness associated with at least one of a data source, a data type, a relationship, a property, or a query capability of the distributed data sources.

34. The system of claim 1, wherein executing at least the portion of the query based on the query execution plan comprises:
deduplicating redundant data from the response to the query, the redundant data being identical data returned by different sub-responses to corresponding portions of the query.

35. A method comprising:
receiving a query for a distributed graph database system that includes multiple distributed data sources, wherein data stored by a first one of the distributed data sources overlaps with data stored by a second one of the distributed data sources;
determining completeness criteria corresponding to the first data source and the second data source after receiving the query;
generating a query execution plan based at least on the completeness criteria corresponding to the first data source and the second data source, the query execution plan indicating an order for querying the distributed data sources during execution of the query by the distributed graph database system;
executing, by the distributed graph database system, at least a portion of the query based on the query execution plan to obtain a response to the query; and
outputting the response to the query following execution of the query.

36. A computer program product storing programming instructions for execution by a processor of a system, the programming instructions, upon execution by the processor, causing the system to perform the following operations:
receiving a query for a distributed graph database system that includes multiple distributed data sources, wherein data stored by a first one of the distributed data sources overlaps with data stored by a second one of the distributed data sources;
determining completeness criteria corresponding to the first data source and the second data source after receiving the query;
generating a query execution plan based at least on the completeness criteria corresponding to the first data source and the second data source, the query execution plan indicating an order for querying the distributed data sources during execution of the query by the distributed graph database system;
executing, by the distributed graph database system, at least a portion of the query based on the query execution plan to obtain a response to the query; and
outputting the response to the query following execution of the query.
